(19) United States
(12) Patent Application Publication
(10) Pub. No.: US 2026/0032508 A1
(43) Pub. Date: Jan. 29, 2026

(54) COMMUNICATION SYSTEM AND METHOD

(71) Applicant: HUAWEI TECHNOLOGIES CO., LTD., Shenzhen (CN)

(72) Inventors: Xudong WANG, Shanghai (CN); Tianxin WANG, Shanghai (CN); Aimin TANG, Shanghai (CN); Zhongfeng LI, Shanghai (CN)

(21) Appl. No.: 19/343,115

(22) Filed: Sep. 29, 2025

Related U.S. Application Data
(63) Continuation of application No. PCT/CN2023/085658, filed on Mar. 31, 2023.

(51) Int. Cl. H04W 28/02; H04W 84/18

(52) U.S. Cl. CPC H04W 28/0289; H04W 84/18

(57) ABSTRACT

A communication system and method are provided. For a wireless mesh (Mesh) network architecture, uplink and downlink multi-hop links and multi-hop sidelinks (sidelink) between users are considered. When a bottleneck area appears in a network, an intra-network node (for example, a terminal device) probes, under coordination of a centralized node (for example, a base station), participant nodes in an idle or inactive (idle/inactive) state in networks that are managed by different centralized nodes, obtains network topology information of a multi-hop participant node, selects, based on a requirement for improvement in overall network performance, an appropriate participant node to join the network, reestablishes a wireless link, and performs network structure reconstruction, to break through a network bottleneck and greatly improve a network throughput.

### CROSS-REFERENCE TO RELATED APPLICATIONS

This is a continuation of International Application No. PCT/CN2023/085658, filed on Mar. 31, 2023, the disclosure of which is hereby incorporated by reference in its entirety.

### TECHNICAL FIELD

This application relates to the communication field, and more specifically, to a communication system and method.

### BACKGROUND

In recent years, to meet an increasing transmission requirement in a wireless network and expand network coverage, network structures of 5G and 6G communication systems start to develop from a single-hop wireless mesh (Mesh) network to a multi-hop wireless mesh (Mesh) network. For example, standardization work on a sidelink (sidelink) and a sidelink relay (sidelink relay) is performed in the 3rd generation partnership project (3GPP) standard TS 23.304. In a wireless mesh network, due to a radio resource shortage, data traffic overload, or the like, a plurality of congestion areas may be generated in a network. These congestion areas are defined as network bottleneck areas, and the network bottleneck areas may also be referred to as bottleneck areas for short. These bottleneck areas greatly reduce a network throughput.

Currently, a relay discovery and relay selection mechanism for resolving the bottleneck area is not applicable to a wireless mesh network architecture. In addition, only a link-level service requirement and performance optimization are considered, and relay node selection and joining are not designed from a perspective of overall network performance. Consequently, it is difficult to effectively improve a network throughput.

### SUMMARY

This application provides a communication system and method. For a wireless mesh network architecture, uplink and downlink multi-hop links and multi-hop sidelinks between users are considered. When a bottleneck area appears in a network, each intra-network node probes, under coordination of a centralized node, participant nodes in an idle/inactive state in different networks, obtains topology information of a multi-hop participant node, selects, based on a requirement for improvement in overall network performance, an appropriate participant node to join the network, reestablishes a wireless link, and performs network structure reconstruction, to break through a network bottleneck and greatly improve a network throughput.

According to a first aspect, a communication system is provided. The system includes a first centralized node (the first centralized node may also be referred to as a first node), at least one intra-network node (the intra-network node may also be referred to as a second node), a second centralized node (the second centralized node may also be referred to as a fourth node), and a participant node (the participant node may also be referred to as a third node). The first node is configured to send indication information to at least one second node, where the indication information indicates the second node to send probing information, and the at least one second node is a node for which the first node performs configuration indication (that is, the at least one second node is a node managed by the first node). The at least one second node is configured to send probing information based on the indication information. The at least one second node is further configured to detect a preamble that is sent by a third node and that is in response to the probing information. The at least one second node is further configured to separately send first information to the first node, where the first information includes an identifier of a preamble detected in each time unit. The first node is further configured to determine multi-hop network topology information based on the first information respectively fed back by the at least one second node.

According to the communication system provided in the first aspect, for a wireless mesh network architecture, uplink and downlink multi-hop links and multi-hop sidelinks between users are considered. The first centralized node indicates the intra-network node to send the probing information. After broadcasting the probing information, the intra-network node feeds back, to the first centralized node, a received preamble (preamble) reported by the participant node. The first centralized node probes, based on information about the preamble detected in each time unit, information about participant nodes in different networks, to determine the multi-hop network topology information, and perform network structure reconstruction, thereby greatly improving a network throughput.

For example, the first centralized node and the second centralized node are different base stations, and both the intra-network node and the participant node may be terminal devices. Optionally, the probing information may also be referred to as a probing information block.

For example, an identifier for sending the preamble by the participant node may be an identifier of the participant node.

In a possible implementation of the first aspect, the participant node is a node in an idle/inactive state in a network.

In a possible implementation of the first aspect, the at least one second node is located in a bottleneck area, the bottleneck area is a bottleneck area that is in a first network and that is managed by the first node, and the bottleneck area includes a plurality of third nodes. In this implementation, when a bottleneck area appears in the first network, the first centralized node indicates the intra-network node to send probing information. After sending the probing information, the intra-network node feeds back, to the first centralized node, a received preamble (preamble) reported by the participant node and managed by another centralized node, to determine the multi-hop network topology information and perform network structure reconstruction, thereby breaking through a network bottleneck and greatly improving a network throughput.

In a possible implementation of the first aspect, the indication information includes time-frequency resource configuration information for sending the probing information.

In a possible implementation of the first aspect, the indication information includes time-frequency resource configuration information for sending the probing information. The system further includes a fourth node (the fourth node may also be referred to as a second centralized node). The third node is a node for which the fourth node performs configuration indication (that is, the third node is a node managed by the fourth node). Before the first centralized node separately sends the indication information to the at least one intra-network node in the bottleneck area, the first centralized node is further configured to send bottleneck request information to the second centralized node, where the bottleneck request information includes at least one of location information of the bottleneck area and expected active time information of the participant node in the bottleneck area; the second centralized node is further configured to send bottleneck request response information to the first centralized node, where the bottleneck request response information includes active time information of the participant node in the bottleneck area, the active time information includes at least one of a active time range and active time periodicity configuration information, and the participant node is a node in an idle/inactive state in a second network; and the first centralized node determines, based on the bottleneck request response information, a time domain resource for sending the probing information. In this implementation, a bottleneck message is exchanged between centralized nodes, to provide strong support for probing participant nodes in different networks. In addition, it can be ensured that the active time information of the participant node is requested and fed back, so that the probing information can be efficiently received by the participant node subsequently.

In a possible implementation of the first aspect, active time that is of the participant node and that is included in the bottleneck request response information and the time domain resource for sending the probing information at least partially overlap. In this implementation, it can be ensured that the probing information sent by the intra-network node can be efficiently and correctly received by the participant node in each bottleneck area, thereby improving efficiency of receiving the probing information.

Optionally, the third node may also be a node for which the first node performs configuration indication (that is, the third node is a node managed by the first node). In this implementation, the first node may independently determine active time information of the third node, so that the active time information of the third node does not need to be obtained through other signaling interaction, thereby reducing signaling resource overheads.

In a possible implementation of the first aspect, the time-frequency resource configuration information for the probing information includes the time-frequency resource occupied for sending the probing information. In this implementation, a time-frequency resource of the probing information is configured by using the centralized node. Because the time-frequency resource that is of the probing information and that is configured by the centralized node corresponds to the active time that is of the participant node in each bottleneck area and that is included in the bottleneck request response information, the probing information sent by the intra-network node can be efficiently received by the participant node, thereby improving efficiency of receiving the probing information, and improving efficiency of discovering a surrounding participant node.

In a possible implementation of the first aspect, the time-frequency resource configuration information for the probing information includes configuration information of a first resource pool and configuration information of a plurality of candidate resources in the first resource pool, the time-frequency resource occupied by the probing information is one of the plurality of candidate resources, a time domain resource of each candidate resource corresponds to a set or a subset of active time of the third node, and the at least one intra-network node is further configured to separately select a target resource from the plurality of candidate resources to send the probing information. In this implementation, the centralized node configures the plurality of candidate resources for each bottleneck area, and the intra-network node in the bottleneck area performs independent selection from the plurality of candidate resources, so that overheads of the indication information can be reduced, and the intra-network node can independently select a resource for broadcasting a PSB, thereby improving flexibility of resource allocation.

In a possible implementation of the first aspect, the at least one intra-network node includes a first intra-network node, the participant node includes a second participant node, and the second participant node is configured to: select an i^{th} time unit from X configured time units; and if the i^{th} time unit is a 1^{st} time unit, send, by the second participant node, a preamble of the second participant node to the first intra-network node in the i^{th} time unit; or if the i^{th} time unit is not a 1^{st} time unit, monitor, by the second participant node in a time unit before the i^{th} time unit, a preamble sent by a surrounding participant node, and send, to the first intra-network node in the i^{th} time unit, a preamble of the second participant node and the preamble that is sent by the surrounding participant node and that is monitored in the time unit before the i^{th} time unit. In this implementation, in a half-duplex working mode, a manner in which the participant node feeds back the preamble may enable the centralized node to efficiently and accurately obtain multi-hop topology information, to perform network structure reconstruction.

In a possible implementation of the first aspect, the at least one intra-network node includes a first intra-network node, the participant node includes a second participant node, and the second participant node is configured to: send a preamble of the second participant node to the first intra-network node in each of first X-1 time units in X configured time units, monitor, in each of the first X-1 time units, a preamble sent by a surrounding participant node, and send, to the first intra-network node in a last time unit in the X time units, the preamble of the second participant node and the preamble that is sent by the surrounding participant node and that is monitored in the first X-1 time units. In this implementation, in a full-duplex working mode, a manner in which the participant node feeds back the preamble can improve efficiency of feeding back the preamble by the participant node, so that the centralized node can efficiently and accurately obtain multi-hop topology information, to perform network structure reconstruction.

For example, the time unit may be a slot, a subframe, a symbol, a radio frame, or the like.

In a possible implementation of the first aspect, the probing information includes at least one of a primary synchronization sequence and a secondary synchronization sequence, current reference time indication information, configuration information for sending a preamble by the participant node, or an identifier of the intra-network node, the configuration information for sending the preamble by the participant node includes at least one of a time domain resource configuration for sending the preamble by the participant node, a threshold for sending the preamble by the participant node, and a preamble sequence set, and the preamble sequence set includes a root sequence and a cyclic shift manner. In this implementation, it can be ensured that the intra-network node successfully communicates with the participant node, the probing information sent by the intra-network node can be correctly received by the participant node, and the preamble fed back by the participant node can be correctly received by the intra-network node, thereby ensuring communication efficiency and improving a communication success rate.

In a possible implementation of the first aspect, that the at least one second node sends the probing information includes: The at least one second node broadcasts the probing information.

According to a second aspect, a communication method is provided. The method includes: A first node (the first node may also be referred to as a first centralized node) sends indication information to at least one second node (the second node may also be referred to as an intra-network node), where the indication information indicates the second node to send probing information, and the at least one second node is a node for which the first node performs configuration indication (that is, the at least one second node is a node managed by the first node). The at least one second node sends probing information based on the indication information. The at least one second node detects a preamble that is sent by a third node (the third node may also be referred to as a participant node) and that is in response to the probing information. The at least one second node separately sends first information to the first node, where the first information includes an identifier of a preamble detected in each time unit. The first node determines multi-hop network topology information based on the first information respectively fed back by the at least one second node.

According to the communication method provided in the second aspect, for a wireless mesh network architecture, uplink and downlink multi-hop links and multi-hop sidelinks between users are considered. The first centralized node indicates the intra-network node to send the probing information. After broadcasting the probing information, the intra-network node feeds back, to the first centralized node, a received preamble (preamble) reported by the participant node. The first centralized node probes, based on information about the preamble detected in each time unit, information about participant nodes in different networks, to determine the multi-hop network topology information, and perform network structure reconstruction, thereby greatly improving a network throughput.

In a possible implementation of the second aspect, the participant node is a node in an idle/inactive state in a network.

In a possible implementation of the second aspect, the indication information includes time-frequency resource configuration information for sending the probing information.

In a possible implementation of the second aspect, the at least one second node is located in a bottleneck area, the bottleneck area is a bottleneck area that is in a first network and that is managed by the first node, and the bottleneck area includes a plurality of third nodes. In this implementation, when a bottleneck area appears in the first network, the first centralized node indicates the intra-network node to send probing information. After sending the probing information, the intra-network node feeds back, to the first centralized node, a received preamble (preamble) reported by the participant node and managed by another centralized node, to determine the multi-hop network topology information and perform network structure reconstruction, thereby breaking through a network bottleneck and greatly improving a network throughput.

In a possible implementation of the second aspect, the indication information includes time-frequency resource configuration information for sending the probing information. The third node is a node for which a fourth node (the fourth node may also be referred to as a second centralized node) performs configuration indication. Before the first centralized node separately sends the indication information to the at least one intra-network node in a bottleneck area, the method further includes: The first centralized node sends bottleneck request information to the second centralized node, where the bottleneck request information includes at least one of location information of the bottleneck area and expected active time information of the participant node in the bottleneck area. The second centralized node sends bottleneck request response information to the first centralized node, where the bottleneck request response information includes active time information of the participant node in the bottleneck area, the active time information includes at least one of active time range and active time periodicity configuration information, and the participant node is a node in an idle/inactive state in the second network. The first centralized node determines, based on the bottleneck request response information, a time domain resource for sending the probing information.

In a possible implementation of the second aspect, active time that is of the participant node and that is included in the bottleneck request response information and the time domain resource for sending the probing information at least partially overlap.

Optionally, the third node may also be a node for which the first node performs configuration indication (that is, the third node is a node managed by the first node). In this implementation, the first node may independently determine active time information of the third node, so that the active time information of the third node does not need to be obtained through other signaling interaction, thereby reducing signaling resource overheads.

In a possible implementation of the second aspect, the time-frequency resource configuration information for the probing information includes: the time-frequency resource occupied for sending the probing information.

In a possible implementation of the second aspect, the time-frequency resource configuration information for the probing information includes configuration information of a first resource pool and configuration information of a plurality of candidate resources in the first resource pool, the time-frequency resource occupied by the probing information is one of the plurality of candidate resources, and a time domain resource of each candidate resource corresponds to a set or a subset of active time of the third node. The method further includes: The at least one intra-network node separately selects a target resource from the plurality of candidate resources to send the probing information.

In a possible implementation of the second aspect, the at least one intra-network node includes a first intra-network node, and the participant node includes a second participant node. The method further includes: The second participant node selects an i^{th} time unit from X configured time units; and if the i^{th} time unit is a 1^{st} time unit, the second participant node sends a preamble of the second participant node to the first intra-network node in the i^{th} time unit; or if the i^{th} time unit is not a 1^{st} time unit, the second participant node monitors, in a time unit before the i^{th} time unit, a preamble sent by a surrounding participant node, and sends, to the first intra-network node in the i^{th} time unit, a preamble of the second participant node and the preamble that is sent by the surrounding participant node and that is detected in the time unit before the i^{th} time unit. In this implementation, in a half-duplex working mode, a manner in which the participant node feeds back the preamble may enable the centralized node to efficiently and accurately obtain multi-hop topology information, to perform network structure reconstruction.

In a possible implementation of the second aspect, the at least one intra-network node includes a first intra-network node, and the participant node includes a second participant node. The method further includes: The second participant node sends a preamble of the second participant node to the first intra-network node in each of first X-1 time units in X configured time units, monitors, in each of the first X-1 time units, a preamble sent by a surrounding participant node, and sends, to the first intra-network node in a last time unit in the X time units, the preamble of the first participant node and the preamble that is sent by the surrounding participant node and that is monitored in the first X-1 time units. In this implementation, in a full-duplex working mode, a manner in which the participant node feeds back the preamble can improve efficiency of feeding back the preamble by the participant node, so that the centralized node can efficiently and accurately obtain multi-hop topology information, to perform network structure reconstruction.

For example, the time unit may be a slot, a subframe, a symbol, a radio frame, or the like.

In a possible implementation of the second aspect, the probing information includes at least one of a primary synchronization sequence and a secondary synchronization sequence, current reference time indication information, configuration information for sending a preamble by the participant node, or an identifier of the intra-network node, the configuration information for sending the preamble by the participant node includes at least one of a time domain resource configuration for sending the preamble by the participant node, a threshold for sending the preamble by the participant node, and a preamble sequence set, and the preamble sequence set includes a root sequence and a cyclic shift manner.

In a possible implementation of the second aspect, that the at least one second node sends the probing information includes: The at least one second node broadcasts the probing information.

For beneficial effects of the possible implementations of the second aspect, refer to the beneficial effects of the possible implementations corresponding to the first aspect. Details are not described herein again.

According to a third aspect, a communication method is provided. The method includes: A first node (the first node may also be referred to as a first centralized node) sends indication information to at least one second node (the second node may also be referred to as an intra-network node), where the indication information indicates the second node to send probing information, and the at least one second node is a node for which the first node performs configuration indication (that is, the at least one second node is a node managed by the first node). The first node receives first information respectively sent by the at least one second node, where the first information includes a preamble, in response to the probing information, that is sent by a third node (the third node may also be referred to as a participant node) and that is detected in each time unit, and the third node is a node for which a fourth node (the fourth node may also be referred to as a second centralized node) performs configuration indication. The first node determines multi-hop network topology information based on the first information respectively fed back by the at least one second node.

According to the communication method provided in the third aspect, for a wireless mesh network architecture, uplink and downlink multi-hop links and multi-hop sidelinks between users are considered. The first centralized node indicates the intra-network node to broadcast the probing information. After sending the probing information, the intra-network node feeds back, to the first centralized node, a received preamble (preamble) reported by the participant node and managed by another centralized node. The first centralized node probes, based on information about the preamble detected in each time unit, information about participant nodes in different networks, to determine the multi-hop network topology information, and perform network structure reconstruction, thereby greatly improving a network throughput.

In a possible implementation of the third aspect, the at least one second node is located in a bottleneck area, the bottleneck area is a bottleneck area that is in a first network and that is managed by the first node, and the bottleneck area includes a plurality of third nodes. In this implementation, when a bottleneck area appears in the first network, the first centralized node indicates the intra-network node to send probing information. After sending the probing information, the intra-network node feeds back, to the first centralized node, a received preamble (preamble) reported by the participant node and managed by another centralized node, to determine the multi-hop network topology information and perform network structure reconstruction, thereby breaking through a network bottleneck and greatly improving a network throughput.

In a possible implementation of the third aspect, the participant node is a node in an idle/inactive state in a network.

In a possible implementation of the third aspect, the indication information includes time-frequency resource configuration information for sending the probing information.

In a possible implementation of the third aspect, the third node is a node for which a fourth node (the fourth node may also be referred to as a second centralized node) performs configuration indication, and the indication information includes time-frequency resource configuration information for sending the probing information. Before the first centralized node separately sends the indication information to the at least one intra-network node in a bottleneck area, the method further includes: The first centralized node sends bottleneck request information to the second centralized node, where the bottleneck request information includes at least one of location information of the bottleneck area and expected active time information of the participant node in the bottleneck area. The first centralized node receives bottleneck request response information from the second centralized node, where the bottleneck request response information includes active time information of the participant node in the bottleneck area, the active time information includes at least one of a active time range and active time periodicity configuration information, and the participant node is a node in an idle or inactive state in a second network. The first centralized node determines, based on the bottleneck request response information, a time domain resource for sending the probing information.

In a possible implementation of the third aspect, active time that is of the participant node and that is included in the bottleneck request response information and the time domain resource for sending the probing information at least partially overlap.

Optionally, the third node is a node for which the first node performs configuration indication (that is, the third node is a node managed by the first node). In this implementation, the first node may independently determine active time information of the third node, so that the active time information of the third node does not need to be obtained through other signaling interaction, thereby reducing signaling resource overheads.

In a possible implementation of the third aspect, the time-frequency resource configuration information for the probing information includes the time-frequency resource occupied for sending the probing information.

In a possible implementation of the third aspect, the time-frequency resource configuration information for the probing information includes configuration information of a first resource pool and configuration information of a plurality of candidate resources in the first resource pool, the time-frequency resource occupied by the probing information is one of the plurality of candidate resources, and a time domain resource of each candidate resource corresponds to a set or a subset of active time of the third node.

In a possible implementation of the third aspect, the probing information includes at least one of a primary synchronization sequence and a secondary synchronization sequence, current reference time indication information, configuration information for sending a preamble by the participant node, or an identifier of the intra-network node, the configuration information for sending the preamble by the participant node includes a time domain resource configuration for sending the preamble by the participant node, a threshold for sending the preamble by the participant node, and a preamble sequence set, and the preamble sequence set includes a root sequence and a cyclic shift manner.

In a possible implementation of the third aspect, that the at least one second node sends the probing information includes: The at least one second node broadcasts the probing information.

For beneficial effects of the possible implementations of the third aspect, refer to the beneficial effects of the possible implementations corresponding to the first aspect. Details are not described herein again.

According to a fourth aspect, a communication apparatus is provided. The communication apparatus includes a unit configured to perform the steps in any one of the third aspect or the possible implementations of the third aspect.

According to a fifth aspect, a communication apparatus is provided. The communication apparatus includes at least one processor and a memory. The processor is coupled to the memory, and the memory stores program instructions. When the program instructions stored in the memory are executed by the processor, the method according to any one of the third aspect or the possible implementations of the third aspect is performed.

According to a sixth aspect, a communication apparatus is provided. The communication apparatus includes at least one processor and an interface circuit. The at least one processor is configured to perform the method according to any one of the third aspect or the possible implementations of the third aspect.

According to a seventh aspect, a network device is provided. The network device includes any communication apparatus provided in the fourth aspect, the fifth aspect, or the sixth aspect.

According to an eighth aspect, a communication apparatus is provided. The communication apparatus includes at least one processor and a memory. The processor is coupled to the memory, the memory stores program instructions, and when the program instructions stored in the memory are executed by the processor, the method performed by the intra-network node or the participant node in any one of the second aspect or the possible implementations of the second aspect is performed.

According to a ninth aspect, a communication apparatus is provided. The communication apparatus includes a unit configured to perform the steps performed by the intra-network node or the participant node in any one of the second aspect or the possible implementations of the second aspect.

According to a tenth aspect, a communication apparatus is provided. The communication apparatus includes at least one processor and an interface circuit. The at least one processor is configured to perform the method performed by the intra-network node or the participant node in any one of the second aspect or the possible implementations of the second aspect.

According to an eleventh aspect, a terminal device is provided, including any communication apparatus provided in the eighth aspect, the ninth aspect, or the tenth aspect.

According to a twelfth aspect, a computer program product is provided. The computer program product includes a computer program. When the computer program is executed by a processor, the computer program is configured to perform the method according to any one of the second aspect or the possible implementations of the second aspect, or is configured to perform the method according to any one of the third aspect or the possible implementations of the third aspect.

According to a thirteenth aspect, a computer-readable storage medium is provided. The computer-readable storage medium stores a computer program. When the computer program is executed, the computer program is configured to perform the method according to any one of the second aspect or the possible implementations of the second aspect, or is configured to perform the method according to any one of the third aspect or the possible implementations of the third aspect.

According to a fourteenth aspect, a chip is provided. The chip includes a processor, configured to: invoke a computer program from a memory and run the computer program, to enable a communication device on which the chip is installed to perform the method according to any one of the second aspect or the possible implementations of the second aspect, or perform the method according to any one of the third aspect or the possible implementations of the third aspect.

### BRIEF DESCRIPTION OF DRAWINGS

FIG. 1 is a diagram of an example of a network scenario of NR sidelink relay discovery and relay selection in a related technology;

FIG. 2 is a diagram of signaling interaction between announcing UE and monitoring UE in the network scenario shown in FIG. 1;

FIG. 3 is a diagram of an example of a network scenario in which a distributed relay selection and joining mechanism based on a channel path loss is used in a related technology;

FIG. 4 is a diagram of an example of a communication system according to this application;

FIG. 5 is a schematic flowchart of an example of a communication method according to this application;

FIG. 6 is a diagram of an example of a bottleneck area according to this application;

FIG. 7 is a diagram of another example of a bottleneck area according to this application;

FIG. 8 is a diagram of an example in which a first centralized node sends indication information to an intra-network node in a bottleneck area according to this application;

FIG. 9 is a diagram of an example in which a first centralized node directly indicates a time-frequency resource for broadcasting a probing information block by each intra-network node according to this application;

FIG. 10 is a diagram of an example in which a first centralized node indicates a plurality of candidate resources for broadcasting a probing information block by an intra-network node according to this application;

FIG. 11 is a diagram of an example in which two participant nodes monitor and send a preamble in a half-duplex configuration according to this application;

FIG. 12 is a diagram of an example in which three participant nodes monitor and send a preamble in a half-duplex configuration according to this application;

FIG. 13 is a diagram of an example in which a plurality of participant nodes monitor and send a preamble in a full-duplex configuration according to this application;

FIG. 14 is a diagram of an example of a topology structure of a participant node and an intra-network node according to this application;

FIG. 15 is a diagram of an example of a network topology structure obtained after a network topology structure is reconstructed according to this application;

FIG. 16 is a block diagram of an example of a communication apparatus according to an embodiment of this application;

FIG. 17 is a block diagram of another example of a communication apparatus according to an embodiment of this application;

FIG. 18 is a block diagram of an example of a communication apparatus according to an embodiment of this application;

FIG. 19 is a block diagram of another example of a communication apparatus according to an embodiment of this application; and

FIG. 20 is a block diagram of an example of a chip system according to an embodiment of this application.

### DESCRIPTION OF EMBODIMENTS

The following describes technical solutions of this application with reference to accompanying drawings.

In descriptions of embodiments of this application, “/” means “or” unless otherwise specified. For example, A/B may indicate A or B. In this specification, “and/or” merely describes an association relationship between associated objects and indicates that three relationships may exist. For example, A and/or B may indicate the following three cases: Only A exists, both A and

B exist, and only B exists. In addition, in the descriptions of embodiments of this application, “a plurality of” means two or more.

The terms “first” and “second” mentioned below are merely intended for the purpose of description, and shall not be understood as an indication or implication of relative importance or implicit indication of a quantity of indicated technical features. Therefore, a feature limited by “first” or “second” may explicitly or implicitly include one or more features. In the descriptions of embodiments, unless otherwise specified, “a plurality of” means two or more.

In embodiments of this application, the terminal device or the network device includes a hardware layer, an operating system layer running on the hardware layer, and an application layer running on the operating system layer. The hardware layer includes hardware such as a central processing unit (central processing unit, CPU), a memory management unit (memory management unit, MMU), and a memory (also referred to as a main memory). The operating system may be any one or more types of computer operating systems that implement service processing through a process (process), for example, a Linux operating system, a Unix operating system, an Android operating system, an iOS operating system, or a Windows operating system. The application layer includes applications such as a browser, an address book, word processing software, and instant messaging software. In addition, a specific structure of an execution body of a method provided in embodiments of this application is not particularly limited in embodiments of this application, provided that a program that records code of the method provided in embodiments of this application can be run to perform communication according to the method provided in embodiments of this application. For example, the execution body of the method provided in embodiments of this application may be the terminal device or the network device, or a functional module that can invoke and execute the program in the terminal device or the network device.

In addition, aspects or features of this application may be implemented as a method, an apparatus, or a product that uses standard programming and/or engineering technologies. The term “product” used in this application covers a computer program that can be accessed from any computer-readable component, carrier, or medium. For example, a computer-readable medium may include but is not limited to: a magnetic storage component (for example, a hard disk, a floppy disk, or a magnetic tape), an optical disc (for example, a compact disc (compact disc, CD) and a digital versatile disc (digital versatile disc, DVD)), a smart card, and a flash memory component (for example, an erasable programmable read-only memory (erasable programmable read-only memory, EPROM), a card, a stick, or a key drive). In addition, various storage media described in this specification may represent one or more devices and/or other machine-readable media that are configured to store information. The term “machine-readable media” may include but is not limited to a radio channel, and various other media that can store, include, and/or carry instructions and/or data.

In a wireless mesh network, due to a radio resource shortage, data traffic overload, or the like, a plurality of congestion areas may be generated in a network. These congestion areas are defined as network bottleneck areas. These bottleneck areas greatly reduce a network throughput.

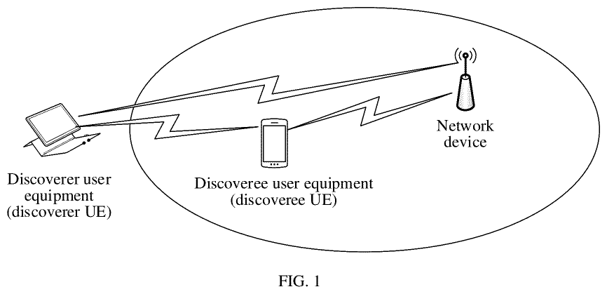

In terms of breaking through a network bottleneck, cellular networks and networks based on the Institute of Electrical and Electronics Engineers (Institute of Electrical and Electronics Engineers, IEEE) 802.11 series standards mainly use conventional congestion control methods, such as adjusting data flow source rates, optimizing link radio resource allocation, and network rerouting. These methods perform congestion control in a fixed network structure (for example, a link capacity, node distribution, and a connection relationship are fixed). To further break through a network bottleneck, the network structure may be reconstructed, for example, a relay node is added to help forward traffic. In recent years, the 3GPP standard TS 23.304 provides a sidelink relay discovery and relay selection mechanism. However, the mechanism considers only a link-level service requirement (for example, a relay node needs to be reselected when quality of a link deteriorates), and does not consider optimization of overall network performance. For example, FIG. 1 is a diagram of a network scenario of NR sidelink relay discovery

and relay selection in a related technology. As shown in FIG. 1, the network scenario includes discoverer user equipment (discoverer user equipment UE, Discoverer UE), discoveree user equipment (Discoveree UE), and a network device (for example, a base station). Both the discoverer UE and the discoveree UE are located in a network managed by the network device. The discoverer UE and the discoveree UE may communicate with each other through a PC5 interface, and the discoverer UE and the discoveree UE may separately communicate with the network device through a Uu interface.

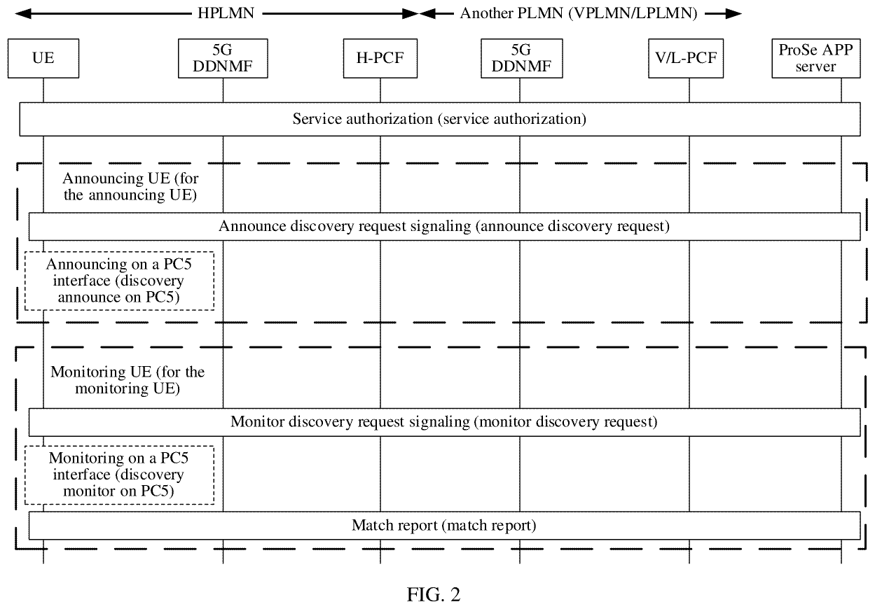

FIG. 2 is a diagram of signaling interaction between discoverer UE (which may also be referred to as announcing UE (announcing UE)) and discoveree UE (which may also be referred to as monitoring UE (monitoring UE)) in the network scenario shown in FIG. 1. As shown in FIG. 2, a network may include a home public land mobile network (home public land mobile network, HPLMN) and another PLMN (for example, including a visited PLMN (visited PLMN, VPLMN), a local PLMN (local PLMN, LPLMN), and the like). A policy control function (policy control function, PCF) network element also includes a home PCF (H-PCF) and a visited or local PCF (V/L-PCF). Both the HPLMN and the another PLMN include a 5G direct discovery name management function (5G direct discovery name management function, 5G DDNMF) network element. In addition, in the flowchart shown in FIG. 2, a proximity service application server (proximity service application server, ProSe APP Server) is further included.

In the scenario shown in FIG. 1, the discoverer UE and the discoveree UE may separately receive a higher layer signaling configuration sent by the base station. For example, for the discoverer UE, the signaling configuration includes: The discoverer UE needs to send (announce) discovery request (Discovery Request) signaling and an ID of a discovery request signaling receiving node (that is, the discoveree UE). For the discoveree UE, the signaling configuration includes: The discoveree UE needs to receive (monitor) discovery request (Discovery Request) signaling. For example, the base station may select, by measuring channel quality indicators (for example, reference signal received power (reference signal received power, RSRP)) of PC5 links between a plurality of UEs and the discoverer UE, a node with maximum RSRP as the discoveree UE, and configure the node as a destination node in the discovery request signaling, that is, announce the ID of the discoveree UE to the discoverer UE in higher layer signaling.

As shown in FIG. 2, the discoverer UE (that is, announcing UE) may send or announce (announce) discovery request (Discovery Request) signaling on a PC5 interface, and the discoveree UE monitors (monitor) the discovery request signaling on the PC5 interface. The discovery request signaling includes a layer 2 source node ID (that is, an ID of the announcing UE), a layer 2 destination node ID (an ID of the monitoring UE), and other necessary indication information.

In the solutions shown in FIG. 1 and FIG. 2, the discoverer UE and the discoveree UE are required to be in a network managed by a same network device (for example, a base station), and a destination node in the discovery request signaling is required to be a node known to the network. As a result, the relay discovery and relay selection mechanism cannot process cross-network relay discovery. In addition, when a discoveree node (Discoveree UE) is in an idle or inactive (idle/inactive) state, existence of these nodes cannot be effectively discovered by using the foregoing mechanism. In addition, the relay selection mechanism is selected only based on quality of a received signal of the PC5 link, and only a link-level service requirement and performance optimization are considered, but overall network performance is not considered. Therefore, it is difficult to effectively improve an overall network throughput.

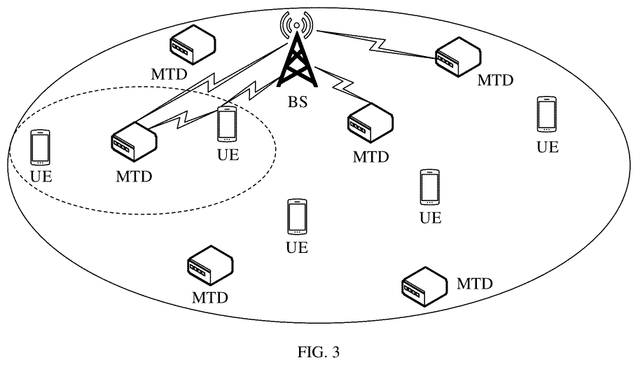

For a 5G device-to-device (device-to-device, D2D) network, a distributed relay selection and joining mechanism based on a channel path loss is used in a related technology. A scenario of the mechanism is shown in FIG. 3, including a network device (for example, a base station (base station, BS)), a plurality of machine-type devices (machine-type device, MTD), and a plurality of UEs. The MTD and the UE may separately communicate with the BS through a Uu interface. The MTD and the UE may communicate with each other through a PC5 interface.

In the scenario shown in FIG. 3, when the MTD detects, through measurement, that a channel path loss between the MTD and the BS is greater than a threshold, the MTD starts a relay selection and joining mechanism. The MTD broadcasts relay request signaling, and UE that receives the signaling and detects that signal strength is greater than a threshold performs contention-based reply, that is, the UE selects, based on a probability, a slot within a configured contention window to send reply signaling to the MTD. The UE that first successfully sends the reply signaling is selected by the MTD as a relay node between the MTD and the BS. In this way, the MTD may use the UE as a relay node to communicate with the BS.

In the example shown in FIG. 3, only uplink and downlink two-hop links are considered, and a multi-hop sidelink is not considered. Therefore, the example is not applicable to a wireless mesh network. The MTD broadcasts the relay request signaling, so that the MTD can obtain only topology information of a node of a surrounding hop, but cannot obtain information of nodes of more hops. In addition, this technology considers only link-level performance optimization, for example, starting a relay selection mechanism when channel quality of a single-hop link is poor, and a criterion for selecting a relay is only link channel quality, and relay node selection and joining are not designed from a perspective of overall network performance. Therefore, it is difficult to improve a network throughput.

It can be learned that the solutions shown in FIG. 1 to FIG. 3 are not applicable to a wireless mesh network architecture. In addition, only a link-level service requirement and performance optimization are considered, and relay node selection and joining are not designed from a perspective of overall network performance. Therefore, it is difficult to improve a network throughput. In a future 6G wireless mesh network architecture, nodes can be flexibly deployed in various modes, and the network has a good reconstruction capability, which creates a condition for reconstructing the network structure.

In view of this, this application provides a communication system and method. For a wireless mesh network architecture, uplink and downlink multi-hop links and multi-hop sidelinks between users are considered. When a bottleneck area appears in a network, each intra-network node probes, under coordination of a centralized node, a participant node in an idle/inactive state in the network, obtains topology information of a multi-hop participant node, selects, based on a requirement for improvement in overall network performance, an appropriate participant node to join the network, reestablishes a wireless link, and performs network structure reconstruction, to finally break through a network bottleneck and greatly improve a network throughput.

For ease of understanding, terms in embodiments of this application are first briefly described.

Centralized node (the centralized node may also be referred to as a first node or a fourth node): In a wireless mesh network architecture, the centralized node is responsible for centralized management, control, and scheduling of a multi-hop sidelink network. For example, the centralized node may be a network device (for example, a base station).

Intra-network node (the intra-network node may also be referred to as a second node): The intra-network node is a node in an active (active) state in a wireless mesh network architecture, and may be used as a source node/destination node/relay node for sidelink transmission. The intra-network node may be a terminal device, a relay node, a network device, or the like. The centralized node can be considered as a special intra-network node.

Participant node (the participant node may also be referred to as a third node): The participant node is a node in an idle/inactive state in a wireless mesh network architecture network. After being detected and discovered, these nodes may participate in network structure reconstruction, that is, can be added to a network to serve as a relay node. Information about this type of node is unknown or incomplete on a network side. The participant node may be a terminal device.

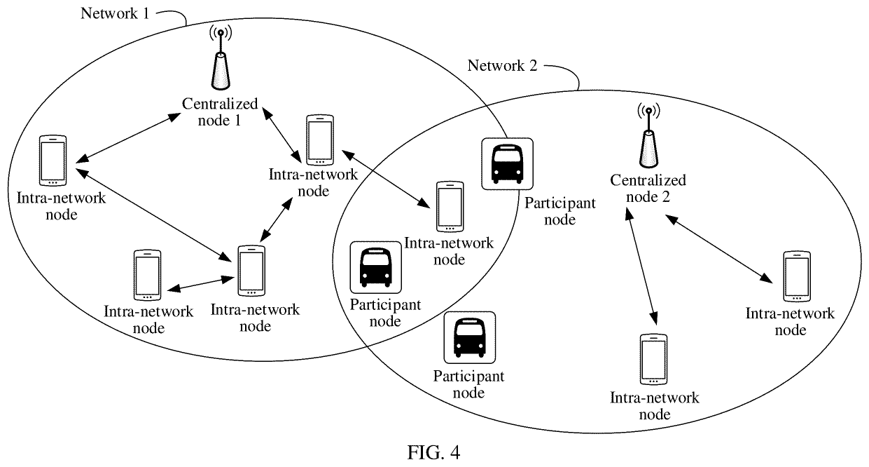

For example, FIG. 4 is a diagram of an example of a communication system according to this application. As shown in FIG. 4, the system includes a plurality of centralized nodes (for example, base stations), for example, a centralized node 1 and a centralized node 2 shown in FIG. 4. Each centralized node manages a network. Network areas managed by different centralized nodes (a network 1 managed by the centralized node 1 and a network 2 managed by the centralized node 2) may overlap. Control signaling may be transmitted between centralized nodes through an

Xn interface (Xn interface). The intra-network node may be connected to a centralized node through a one-hop or multi-hop sidelink, to form a current network topology structure for uplink/downlink or sidelink data transmission. The participant node does not establish links with other network elements and is in an idle/inactive state. According to the communication method provided in this application, the participant node may join a network, reestablish a wireless link, and perform network structure reconstruction, to finally break through a network bottleneck and greatly improve a network throughput.

It should be understood that the communication system provided in this embodiment of this application may include an integrated access and backhaul (integrated access and backhaul, IAB) network, a multi-hop sidelink network, and the like. This is not limited herein in this embodiment of this application.

In the system shown in FIG. 4, the centralized node is mainly configured to implement functions such as a radio physical layer function, resource scheduling and radio resource management, radio access control, and mobility management.

For example, the communication system shown in FIG. 4 may be a 3GPP-related cellular system, for example, a 4G or 5G mobile communication system (including standalone networking and non-standalone networking), or a future-oriented evolved system (for example, a 6G mobile communication system), or may be an open random access network (open RAN, O-RAN or ORAN), a cloud radio access network (cloud radio access network, CRAN), or a wireless fidelity (wireless fidelity, Wi-Fi) system, or may be a communication system that integrates the foregoing two or more systems. This is not limited herein in this embodiment of this application.

The centralized node may also be sometimes referred to as a radio access network (radio access network, RAN) device, an access network device, a network device, a RAN node, a RAN entity, an access node, or the like, and forms a part of the communication system, to help the intra-network node and the participant node implement radio access. In the communication system shown in FIG. 4, a plurality of centralized nodes may be nodes of a same type, or may be nodes of different types.

In a possible scenario, the centralized node may be a base station (base station), an evolved NodeB (evolved NodeB, NodeB), an access point (access point, AP), a transmission reception point (transmission reception point, TRP), a next generation NodeB (next generation NodeB, gNB), a next generation base station in a 6th generation (6th generation, 6G) mobile communication system, a base station in a future mobile communication system, an access node in a Wi-Fi system, or the like. The centralized node may be a macro base station, a micro base station, an indoor base station, a relay node, a donor node, or a radio controller in a CRAN scenario.

Optionally, the centralized node may alternatively be a server, a vehicle, a vehicle-mounted device, or the like. For example, the access network device in a vehicle-to-everything (vehicle-to-everything, V2X) technology may be a road side unit (road side unit, RSU). All or some functions of the centralized node in this application may alternatively be implemented by using a software function running on hardware, or may be implemented by using an instantiated virtualization function on a platform (for example, a cloud platform). Alternatively, the radio access network device in this application may be a logical node, a logical module, or software that can implement all or some functions of the radio access network device.

In an NR technology, the centralized node (for example, a gNB) may include one gNB central unit (Central Unit, CU) and one or more gNB distributed units (Distributed Unit, DU). The gNB-CU and the gNB-DU are different logical nodes, and may be deployed on different physical devices or deployed on a same physical device.

The intra-network node and/or the participant node may also be referred to as a terminal device, a terminal, user equipment (user equipment, UE), a mobile station, a mobile terminal, or the like. The intra-network node and/or the participant node may be widely used in various scenarios, for example, D2D, vehicle-to-everything (vehicle-to-everything, V2X) communication, machine-type communication (machine-type communication, MTC), the internet of things (internet of things, IOT), virtual reality, augmented reality, industrial control, autonomous driving, telemedicine, a smart grid, smart furniture, smart office, smart wearable, smart transportation, and a smart city. For example, the intra-network node and/or the participant node may be a mobile phone, a tablet computer, a computer with a wireless transceiver function, a wearable device, a vehicle, an uncrewed aerial vehicle, a helicopter, an aircraft, a ship, a robot, a robot arm, a smart home device, or the like. A device form of the terminal is not limited in embodiments of this application.

It should be understood that, in embodiments of this application, the “centralized node” may be further described differently. For example, the “centralized node” may also be referred to as a network device, a RAN node, an access network device, a radio access network device, or the like. In this application, unless otherwise specified, a “centralized node” is used for description below, where the centralized node is an original description of a radio access network device (for example, a base station).

It should be further understood that the communication system shown in FIG. 4 is merely an example, and should not constitute any limitation on the communication system applicable to embodiments of this application. For example, the communication system shown in FIG. 4 may further include more or fewer network nodes, for example, a centralized node, an intra-network node, or a participant node. The centralized node, the intra-network node, and the participant node included in the communication system shown in FIG. 4 may be the foregoing access network devices or terminal devices in various forms. Details are not shown one by one in the figure in embodiments of this application.

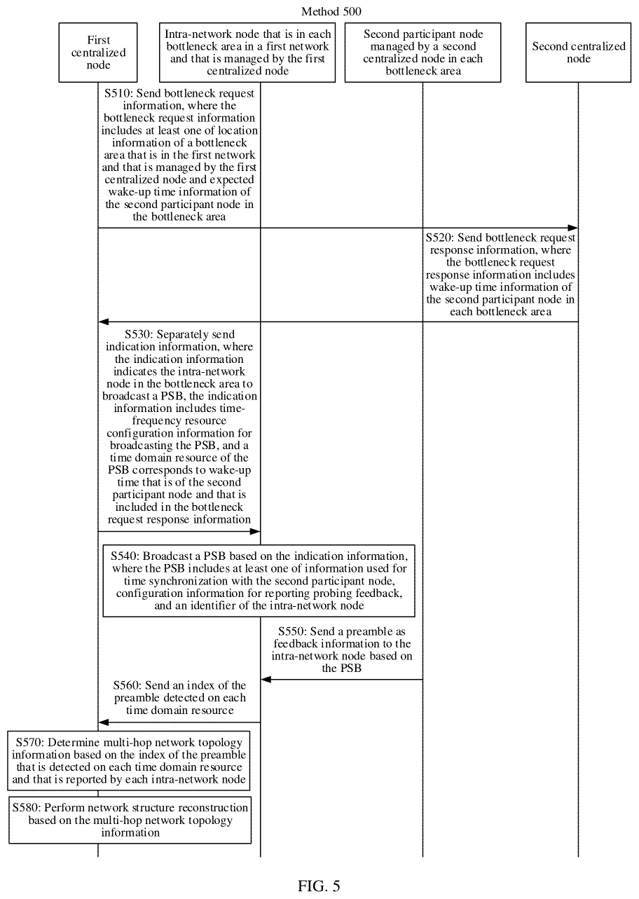

FIG. 5 is a schematic flowchart of an example of a communication method according to this application. The method 500 may be applied to the scenario shown in FIG. 4, and certainly may also be applied to another communication scenario. This is not limited in this embodiment of this application.

It should be understood that in this embodiment of this application, the method is described by using an example in which the node is used as an execution body for performing the method. By way of example, and not limitation, the node in this application may be a chip, a chip system, or a processor that supports the node in implementing the method, or may be a logical node, a logical module, or software that can implement all or some node functions.

It should be further understood that, in this application, “sending information to . . . (node)” may be understood as that a destination end of the information is the node, and may include directly or indirectly sending information to the node. “receiving information from . . . (node) or receiving information from a node” may be understood as that a source end of the information is the node, and may include directly or indirectly receiving information from the node. Necessary processing, such as a format change, may be performed on the information between the source end and the destination end for information sending. However, the destination end can understand valid information from the source end. A similar expression in this application may be understood similarly. Details are not described herein again.

As shown in FIG. 5, the method 500 shown in FIG. 5 may include S510 to S580. The following describes in detail the steps in the method 500 with reference to FIG. 5.

S510: A first centralized node (the first centralized node may also be referred to as a first node) sends bottleneck request information (or may be referred to as bottleneck request signaling) to a second centralized node (the second centralized node may also be referred to as a fourth node), where the bottleneck request information includes at least one of location information of a bottleneck area that is in a first network and that is managed by the first centralized node and expected active time information of a second participant node (the second participant node may also be referred to as a third node) in the bottleneck area, and the second participant node is a node that is in a second network and that is managed by the second centralized node (that is, the second participant node is a node for which the second centralized node performs configuration indication). Correspondingly, the second centralized node receives the bottleneck request information.

Optionally, the “second participant node” may also be referred to as a “participant node”, and the “participant node” and the “second participant node” each are a participant node that is in the second network and that is managed by the second centralized node (that is, a node for which the second centralized node performs configuration information).

Optionally, in a possible implementation, one or more bottleneck areas may exist in the first network, and the one or more bottleneck areas are managed by the first centralized node. Therefore, the first centralized node may determine time information of data flow transmission that causes congestion in each bottleneck area. After determining the time information of data flow transmission, the first centralized node may determine, based on the time information, expected active time information of the second participant node in each bottleneck area.

For example, assuming that time of data flow transmission that causes congestion in a first bottleneck area are several slots (slot) or subframes (subframe), the expected active time information of the second participant node in the first bottleneck area may be the foregoing several slots or subframes. Alternatively, time of data flow transmission that causes congestion in the first bottleneck area may be a periodic time period. For example, if start time is a slot 2, and an interval periodicity is one slot, time of data flow transmission that causes congestion is a slot 1, a slot 3, a slot 5, a slot 7, and the like. In this case, the expected active time information of the second participant node in the first bottleneck area may be the foregoing periodic time period (for example, including a time range and a periodicity configuration). Alternatively, time of data flow transmission that causes congestion in the first bottleneck area may be a start moment and an end moment, for example, a slot 2 to a slot 7. In this case, the expected active time information of the second participant node in the first bottleneck area may be the foregoing start moment and an end moment.

In other words, in this embodiment of this application, the expected active time information of the second participant node in each bottleneck area may be determined based on the time information of data flow transmission that causes congestion in each bottleneck area.

It may be understood that time of data flow transmission that causes congestion in different bottleneck areas may be different, and expected active time of the second participant node in the different bottleneck areas may also be different.

For example, the first centralized node may send bottleneck request information to the second centralized node through an Xn interface (Xn interface).

In this embodiment of this application, the bottleneck request information is used to request active time information of the second participant node in each bottleneck area.

For example, the active time information may include at least one of a active time range, a wake-up periodicity configuration, and the like. Specific content included in the active time information is not limited in this embodiment of this application, provided that the first centralized node can determine specific active time of the second participant node based on the active time information.

It should be understood that, in this embodiment of this application, in a possible implementation, the second participant node may be a node that is in a second network and that is managed by the second centralized node, and the second participant node is currently in an idle/inactive state.

It should be further understood that any bottleneck area may include one or more intra-network nodes, and these intra-network nodes may communicate with each other and transmit data through a PC5 interface. The intra-network node may be connected to the centralized node through a one-hop or multi-hop sidelink link. Uplink and downlink data and signaling transmission may be performed between the intra-network node and the first centralized node through a Uu interface. In addition, because there may be one or more bottleneck areas in the first network, the following two cases may occur:

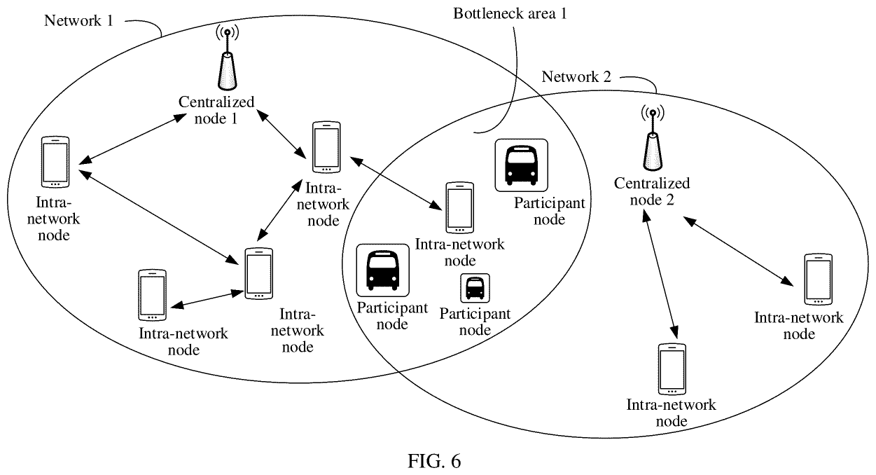

In a first case, participant nodes in all bottleneck areas in the first network are managed by the second centralized node. In this case, the bottleneck request information may include location information of all the bottleneck areas in the first network and expected active time information of the second participant node in each bottleneck area. For example, in the example shown in FIG. 6, it is assumed that there is only one bottleneck area (a bottleneck area 1 shown in FIG. 6) in a network 1, the bottleneck area 1 is an overlapping area between the network 1 and a network 2, the bottleneck area 1 includes three participant nodes, which are all nodes in the network 2 that are managed by the second centralized node (that is, a centralized node 2), and the three participant nodes are all managed by the centralized node 2.

In a second case, participant nodes in some of all bottleneck areas in the first network are managed by the second centralized node.

For the second case, in a possible implementation, the bottleneck request information may include location information of the some bottleneck areas and expected active time information of the second participant node in the some bottleneck areas.

For the second case, in another possible implementation, the bottleneck request information may include location information of all the bottleneck areas in the first network and expected active time information of the second participant node in the bottleneck areas.

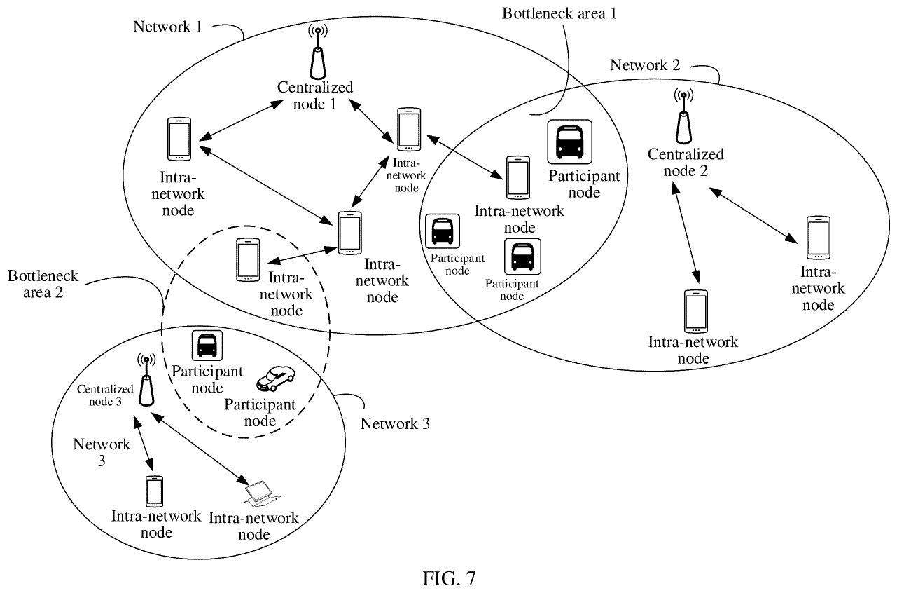

For example, in the example shown in FIG. 7, the network I managed by the centralized node 1 includes two bottleneck areas (a bottleneck area 1 and a bottleneck area 2 shown in FIG. 7), and the bottleneck area 1 includes three participant nodes, which are all nodes in the network 2 that are managed by the centralized node 2. The bottleneck area 2 includes two participant nodes, which are all nodes in a network 3 managed by a centralized node 3.

For example, for the scenario shown in FIG. 7, in a possible implementation, the centralized node 1 sends bottleneck request information to the centralized node 2, where the bottleneck request information includes location information of the bottleneck area 1 and expected active time information of a participant node in the bottleneck area 1. In addition, the centralized node 1 sends bottleneck request information to the centralized node 3, where the bottleneck request information includes location information of the bottleneck area 2 and expected active time information of a participant node in the bottleneck area 2.

Optionally, in S510, in another possible implementation, the bottleneck request information may not include expected active time information of the second participant node in the bottleneck area. That is, the bottleneck request information includes location information of one or more bottleneck areas managed by the first centralized node.

In the following example, descriptions are provided by using an example in which there are a plurality of bottleneck areas in the first network, each bottleneck area includes a plurality of intra-network nodes, and participant nodes (that is, the second participant node) in all bottleneck areas are all managed by the second centralized node.

S520: After receiving the bottleneck request information, the second centralized node sends bottleneck request response information to the first centralized node, where the bottleneck request response information includes active time information of the second participant node in each bottleneck area. Correspondingly, the first centralized node receives the bottleneck request response information.

Optionally, in a possible implementation, if the bottleneck request information sent by the first centralized node includes location information of each bottleneck area and expected active time information of the second participant node in each bottleneck area, after receiving the bottleneck request information, the second centralized node first determines, based on the location information of the bottleneck area, information about a participant node (that is, the second participant node) that is included in each bottleneck area and that is managed or controlled by the second centralized node. (for example, including actual active time information of the second participant node), and then adjusts the active time information of the second participant node based on the active time information of the second participant node that is expected by the first centralized node. For example, the second centralized node adjusts actual active time and an actual wake-up periodicity (that is, original active time and an original wake-up periodicity of a participant node managed or controlled by the second centralized node) of a participant node (a node that is in an idle/inactive state and that is managed or controlled by the second centralized node in each bottleneck area) to be the same as active time and a wake-up periodicity of the participant node that are expected by the first centralized node; or adjust actual active time and an actual wake-up periodicity of the participant node to a subset of active time and a subset of wake-up periodicities of the participant node that are expected by the first centralized node; or adjust actual active time of the participant node to at least partially overlap active time of the participant node that is expected by the first centralized node. Then, the second centralized node sends adjusted active time information of the second participant node in each bottleneck area to the first centralized node by using the bottleneck request response information.

For example, it is assumed that the active time and the wake-up periodicity of the participant node that are expected by the first centralized node are respectively: A active time period is a slot 1, and an interval periodicity is one slot. In other words, the active time of the participant node that is expected by the first centralized node is a slot 1, a slot 3, a slot 5, a slot 7, and the like. The second centralized node may adjust, based on the information, the actual active time and periodicity of the participant node as follows: The active time period is the slot 1, and the interval period is one slot; or may adjust the actual active time and periodicity of the participant node as follows: The active time period is last five symbols in a slot 1, and the interval periodicity is one slot; or may adjust the actual active time and periodicity of the participant node as follows: The active time period is a slot 1 and a slot 2, and the interval period is one slot, that is, adjust the actual active time of the participant node to a slot 1 and a slot 2, a slot 4 and a slot 5, a slot 7 and a slot 8, and the like.

For another example, assuming that the active time of the participant node that is expected by the first centralized node is a slot 1 to a slot 3, the second centralized node may adjust, based on the information, the actual active time and periodicity of the participant node to a slot 1 to a slot 3, or a slot 1 and a slot 2, or a slot 2 and a slot 3, or a slot 1 to a slot 4.

In other words, in this embodiment of this application, the second centralized node may adjust, based on the expected active time information of the participant node in each bottleneck area, the actual active time information of the second participant node managed by the second centralized node in each bottleneck area, so that adjusted actual active time of the second participant node and the active time of the participant node that is expected by the first centralized node are matched, for example, are the same or at least partially overlap in time. In this manner, it can be ensured that a probing information block (which may also be referred to as probing information) can be efficiently received by the second participant node (that is, received within active time of the second participant node) subsequently. In addition, because the active time of the participant node that is expected by the first centralized node is related to the time information of data flow transmission that causes congestion in the bottleneck area, the actual active time of the second participant node is adjusted to match the active time of the participant node that is expected by the first centralized node, so that the active time of the second participant node matches the time of data flow transmission that causes congestion, thereby resolving congestion by using the second participant node in the active time period of the second participant node, and ensuring efficiency and a success rate of resolving congestion.

Optionally, in another possible implementation, if the bottleneck request information includes the location information of the bottleneck area and the expected active time information of the second participant node in the bottleneck area, after receiving the bottleneck request information, the second centralized node may not adjust the original active time and periodicity of the participant node managed or controlled by the second centralized node in each bottleneck area, but directly sends, to the first centralized node by using the bottleneck request response information, the original active time and periodicity of the participant node (that is, the actual active time and periodicity of the participant node) managed or controlled by the second centralized node in each bottleneck area.

Optionally, in another possible implementation, if the bottleneck request information includes the location information of the bottleneck area, but does not include the expected active time information of the second participant node in the bottleneck area, after receiving the bottleneck request information, the second centralized node may not adjust the original active time and periodicity of the participant node managed or controlled by the second centralized node in each bottleneck area, but directly sends, to the first centralized node by using the bottleneck request response information, the original active time and periodicity of the participant node (that is, the actual active time and periodicity of the participant node) managed or controlled by the second centralized node in each bottleneck area.

Optionally, in another possible implementation, if the bottleneck request information includes the expected active time information of the second participant node in the bottleneck area, but does not include the location information of the bottleneck area, after receiving the bottleneck request information, the second centralized node may adjust or not adjust the original active time and periodicity of the participant node managed or controlled by the second centralized node in each bottleneck area. In a case in which no adjustment is performed, the second centralized node sends, to the first centralized node by using the bottleneck request response information, the original active time and periodicity of the participant node (that is, the actual active time and periodicity of the participant node) managed or controlled by the second centralized node in each bottleneck area. In a case in which adjustment is performed, the second centralized node sends adjusted active time information of the second participant node in each bottleneck area to the first centralized node by using the bottleneck request response information.

In S510 and S520, a bottleneck message is exchanged between centralized nodes, to provide strong support for probing participant nodes in different networks. In addition, it can be ensured that the active time information of the second participant node is requested and fed back, so that the probing information block can be efficiently received by the second participant node subsequently.

It should be understood that in this application, the “detection information block” may also be referred to as (or equivalent to) “detection information”.

Certainly, participant nodes in some of all bottleneck areas in the first network are managed by the second centralized node, and the bottleneck request information includes location information of all the bottleneck areas in the first network and expected active time information of the second participant node in the bottleneck areas. In this case, after receiving the bottleneck request information, the second centralized node may adjust only active time of participant nodes in the some bottleneck areas, and then send adjusted active time information of the second participant node in the some bottleneck areas to the first centralized node by using the bottleneck request response information. For participant nodes that are not managed by the second centralized node, the second centralized node may announce, to the first centralized node in the bottleneck request response information, that these participant nodes are not controlled or managed by the second centralized node, or may not reply to the active time information of these participant nodes.

It should be understood that, when the second participant node is a participant node that is in the second network and that is managed by the second centralized node, that is, when the second participant node is a node for which the second centralized node performs configuration indication, the method 500 may include S510 and S520.

It should be further understood that the second participant node may be a participant node that is in the first network and that is managed by the first centralized node, and the second participant node is currently in an idle/inactive state. Participant nodes in all or some bottleneck areas in the first network are all managed by the first centralized node. In other words, the second participant node may also be a node that is in the first network and that is managed by the first centralized node, that is, the second participant node may also be a node for which the first centralized node performs configuration indication. In this case, the method 500 may not include S510 and S520.

S530: The first centralized node separately sends indication information to the intra-network node (the intra-network node may also be referred to as a second node) in each bottleneck area based on the bottleneck request response information, where the indication information indicates the intra-network node in the bottleneck area to broadcast a probing information block (probing signal block, PSB). The indication information includes time-frequency resource configuration information for broadcasting the probing information block. A time domain resource of the probing information block corresponds to active time that is of the second participant node and that is included in the bottleneck request response information. Correspondingly, the intra-network node in each bottleneck area separately receives the indication information.

In this embodiment of this application, the intra-network node (or the second node) in each bottleneck area is an intra-network node managed by the first centralized node, that is, the intra-network node (or the second node) is an intra-network node that is in the first network and that is managed by the first centralized node.

It should be further understood that descriptions are provided below by using an example in which the intra-network node sends a PSB in a broadcast manner. In another implementation of this application, the intra-network node may alternatively send a PSB in another manner, for example, in a unicast manner or a multicast manner. This is not limited in this embodiment of this application.

After receiving the bottleneck request response information, the first centralized node may send the indication information to the intra-network node in each bottleneck area. For example, the indication information may be radio resource control (radio resource control, RRC) signaling, other higher layer signaling, or physical layer signaling. This is not limited in this embodiment of this application. The indication information indicates the intra-network node in each bottleneck area to broadcast a PSB. For example, the PSB may be a UE-specific PSB (UE-specific PSB). All participant nodes managed by the second centralized node in any bottleneck area may receive a PSB that is broadcast by an intra-network node in the bottleneck area.

It should be understood that, in this embodiment of this application, the indication information includes time-frequency resource information for broadcasting the probing information block by the intra-network node. A time domain resource for broadcasting the probing information block by the intra-network node corresponds to the active time that is of the second participant node in each bottleneck area and that is included in the bottleneck request response information. For example, the time domain resource for broadcasting the probing information block by the intra-network node is the same as the active time of the second participant node, or the time domain resource for broadcasting the probing information block by the intra-network node at least partially overlaps the active time of the second participant node. In this case, it can be ensured that the probing information that is broadcast by the intra-network node can be efficiently and correctly received by the participant node in each bottleneck area, thereby improving efficiency of receiving the probing information block.

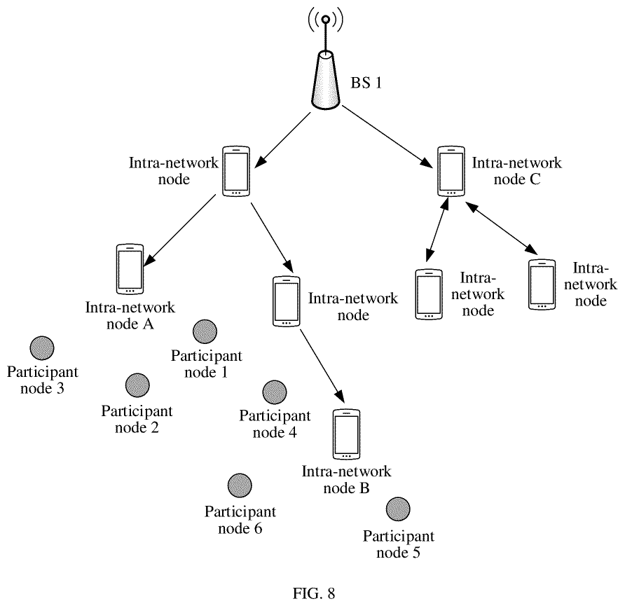

For example, FIG. 8 is a diagram of an example in which a first centralized node sends indication information to an intra-network node in a bottleneck area. In the example shown in FIG. 8, the first centralized node (BS 1) separately sends RRC signaling to three intra-network nodes (an intra-network node A, an intra-network node B, and an intra-network node C) in the bottleneck area, where the RRC signaling is used to trigger the intra-network node A, the intra-network node B, and the intra-network node C to separately broadcast a PSB. The intra-network node A, the intra-network node B, and the intra-network node C are all in a network managed by the BS 1. In the example shown in FIG. 8, six participant nodes (participant nodes 1 to 6) are included. The six participant nodes are all managed and controlled by a second centralized node (BS 2), and the six participant nodes are all in an idle/inactive state. Information about the six participant nodes is unknown or incomplete for the BS 1, and the participant nodes wake up within active time included in bottleneck request response information. Optionally, the intra-network node A, the intra-network node B, and the intra-network node C may be in a same bottleneck area, or may be in different bottleneck areas. This is not limited in this embodiment of this application.

In the example shown in FIG. 8, when the BS 1 sends RRC signaling to the intra-network nodes A and B, the RRC signaling may be transited by another intra-network node.

In a possible implementation, the time-frequency resource information that is for broadcasting the probing information block by the intra-network node and that is included in the indication information may be centrally allocated by the first centralized node, that is, the first centralized node directly indicates, in the indication information, a time-frequency resource for broadcasting the probing information block by each intra-network node.

For example, FIG. 9 is a diagram of an example in which a first centralized node directly indicates a time-frequency resource for broadcasting a probing information block by each intra-network node. As shown in FIG. 9, assuming that there are three intra-network nodes (an intra-network node 1, an intra-network node 2, and an intra-network node 3), the first centralized node may directly indicate, in the indication information, the time-frequency resource for broadcasting the probing information block by each intra-network node. As shown in FIG. 9, assuming that a time-frequency resource for broadcasting a PSB 1 by the intra-network node 1 is a slot 1 and a slot 2 and subcarriers (subcarrier) 1 and 2, it may be considered that in a bottleneck area in which the intra-network node 1 is located, active time of the second participant node managed by the second centralized node is a slot 1 and a slot 2. If a time-frequency resource for broadcasting a PSB 2 by the intra-network node 2 is a slot 1 and a slot 2 and subcarriers (subcarrier) 4 and 5, it may be considered that in a bottleneck area in which the intra-network node 2 is located, active time of the second participant node managed by the second centralized node is a slot 1 and a slot 2. If a time-frequency resource for broadcasting a PSB 3 by the intra-network node 3 is a slot 6 and a slot 7 and subcarriers (subcarrier) 3 and 4, it may be considered that in a bottleneck area in which the intra-network node 3 is located, active time of the second participant node managed by the second centralized node is a slot 6 and a slot 7.

It may be understood that, for different bottleneck areas, time-frequency resources that are of the probing information block and that are configured by the first centralized node for the intra-network node in the bottleneck area may be different.

It should be further understood that, for a bottleneck area, a time-frequency resource that is of the probing information block and that is configured by the first centralized node for an intra-network node in the bottleneck area corresponds to active time of a participant node in the bottleneck area in the bottleneck request response information.

A time-frequency resource of the probing information block is configured by using the centralized node. Because the time-frequency resource that is of the probing information block and that is configured by the centralized node corresponds to the active time that is of the participant node in each bottleneck area and that is included in the bottleneck request response information, the probing information block that is broadcast by the intra-network node can be efficiently received by the participant node, thereby improving efficiency of receiving the probing information block, and improving efficiency of discovering a surrounding participant node.

In another possible implementation, the time-frequency resource occupied by the probing information block may alternatively be independently selected by each intra-network node. In this case, the first centralized node may configure a plurality of candidate resources for each bottleneck area. For an intra-network node in each bottleneck area, the first centralized node may indicate the plurality of candidate resources to the intra-network node in the bottleneck area by using the indication information, and the intra-network node in the bottleneck area performs independent selection from the plurality of candidate resources. For a plurality of candidate resources corresponding to a bottleneck area, the plurality of candidate resources may correspond to active time of a participant node in each bottleneck area in the bottleneck request response information.

In a possible implementation, the first centralized node may configure one resource pool for one or more intra-network nodes. For example, the resource pool may be a two-dimensional resource mesh defined by using a quantity of slots (certainly, may also be another time unit, for example, a subframe) and a quantity of subcarriers (certainly, may also be another frequency domain unit). The resource pool indicates a resource area that can be used by the intra-network node to broadcast a PSB. In a possible implementation, when determining a time domain range and a frequency domain range of the resource pool, the first centralized node may not consider the active time information included in the bottleneck request response information. The resource pool includes a plurality of candidate resources. In other words, the plurality of candidate resources may be a subset of the resource pool. Time domain information of the candidate resource needs to correspond to active time included in the bottleneck request response information. Each intra-network node may select, from the plurality of candidate resources, a target resource based on an actual requirement, a selection status of another intra-network node (avoiding a conflict of a selected resource), and the like to broadcast a PSB. In other words, the target resource finally selected by the intra-network node for broadcasting the PSB may be a subset of the plurality of candidate resources.

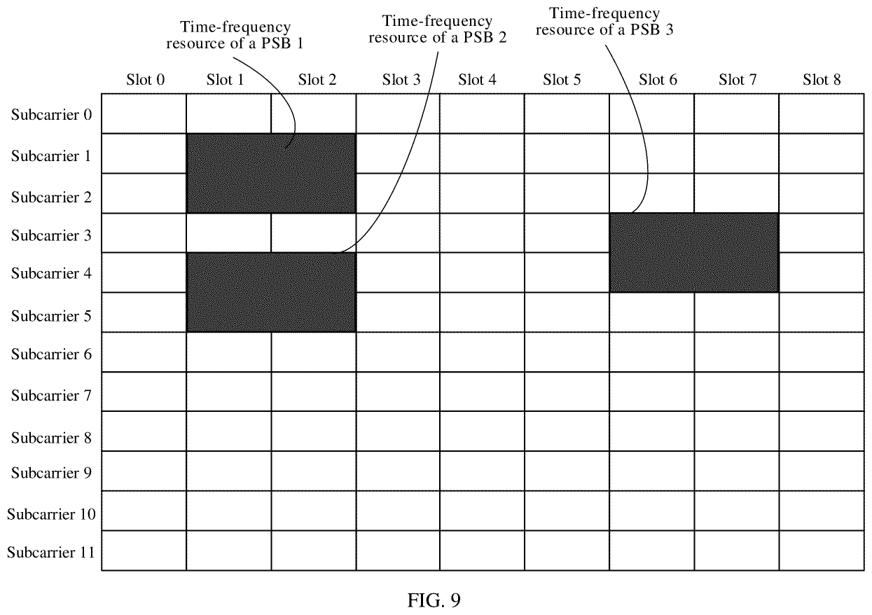

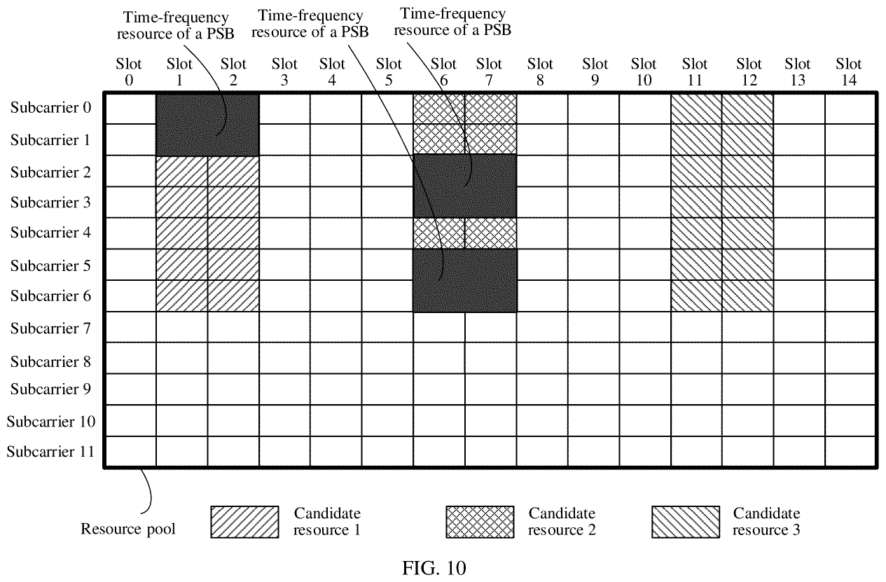

For example, FIG. 10 is a diagram of an example in which a first centralized node indicates a plurality of candidate resources for broadcasting a probing information block by an intra-network node. The first centralized node may configure a resource pool (a slot 0 to a slot 14 and a subcarrier 0 to a subcarrier 11). The resource pool includes a plurality of candidate resources. For example, as shown in FIG. 10, a candidate resource 1 is a slot 1 and a slot 2 and subcarriers (subcarrier) 0 to 6; a candidate resource 2 is a slot 6 and a slot 7 and subcarriers (subcarrier) 0 to 6; and a candidate resource 3 is a slot 11 and a slot 12 and subcarriers (subcarrier) 0 to 6. In this case, it may be considered that in a bottleneck area in which the intra-network node is located, active time information of a participant node managed by another centralized node is as follows: A time length for each time of wake-up is two slots, an interval periodicity is three slots, and a active time range is a slot 1 and a slot 2.

After receiving location information of the plurality of candidate time-frequency resources by using the indication information, the intra-network node may select one time-frequency resource from the plurality of candidate time-frequency resources to send (broadcast) a PSB. For example, as shown in FIG. 10, the intra-network node may choose to broadcast a PSB on subcarriers (subcarrier) 0 and 1 in a slot 1 and a slot 2, or may choose to broadcast a PSB on subcarriers (subcarrier) 2 and 3 in a slot 6 and a slot 7, or may choose to broadcast a PSB on subcarriers (subcarrier) 5 and 6 in a slot 6 and a slot 7.

It may be understood that the first centralized node may configure different candidate resources for different bottleneck areas.

It should be further understood that, for a bottleneck area, a plurality of candidate resources configured by the first centralized node for the bottleneck area correspond to active time of a participant node in the bottleneck area in the bottleneck request response information.

The centralized node configures the plurality of candidate resources for each bottleneck area, and the intra-network node in the bottleneck area performs independent selection from the plurality of candidate resources, so that overheads of the indication information can be reduced, and the intra-network node can independently select a resource for broadcasting a PSB, thereby improving flexibility of resource allocation.

Optionally, in a possible implementation, if the second participant node is a participant node that is in the first network and that is managed by the first centralized node, the first centralized node may also configure a time-frequency resource of the PSB in the foregoing two manners (directly indicating a resource or configuring a candidate resource), and the active time information of the second participant node may be independently determined by the first centralized node instead of being determined in S510 and S520, that is, the method 500 may not include S510 and S520. Therefore, the active time information of the second participant node does not need to be obtained through other signaling interaction, thereby reducing signaling resource overheads. In this case, S530 may also be replaced with the following: The first centralized node sends indication information to the intra-network node (the intra-network node may also be referred to as a second node) in each bottleneck area, where the indication information indicates the intra-network node in the bottleneck area to send a PSB. The indication information includes time-frequency resource configuration information for sending the probing information block. Correspondingly, the intra-network node in each bottleneck area separately receives the indication information.

Optionally, the second participant node may not be located in the bottleneck area in the first network, but may be located at any location that is in the first network and that is managed by the first centralized node, for example, a normal network area. In this case, S530 may be replaced with the following: The first centralized node sends indication information to at least one intra-network node (the intra-network node may also be referred to as a second node), where the indication information indicates the intra-network node to send a PSB. The indication information includes time-frequency resource configuration information for sending the probing information block. Correspondingly, the intra-network node separately receives the indication information.

S540: The intra-network node in each bottleneck area broadcasts a PSB based on the indication information, where the PSB includes at least one of information used for time synchronization with the second participant node, configuration information for reporting probing feedback, and an identifier of the intra-network node. Correspondingly, the second participant node in each bottleneck area receives the PSB.

S550: After receiving the PSB, the second participant node sends a preamble (preamble) as feedback information to the intra-network node based on the PSB.

S560: After receiving the preamble sent by the second participant node, each intra-network node sends, to the first centralized node, an index of the preamble detected on each time domain resource.

It may be understood that, for each bottleneck area, each intra-network node in the bottleneck area needs to perform S540 to S560. In this case, the second participant node is a node that is in an idle/inactive state and that is controlled or managed by the second centralized node in each bottleneck area.

The following uses an intra-network node 1 as an example for description. The intra-network node 1 may be any intra-network node that is in any bottleneck area (assumed as a bottleneck area 1) in a network and that is managed by the first centralized node, and the second participant node is a participant node that receives a PSB that is broadcast by the intra-network node 1.

After receiving the indication information, the intra-network node 1 may broadcast the PSB.

For example, information that is in the PSB and that is used for time synchronization with the second participant node may include the following two types:

A first type is a synchronization sequence configuration, that is, a primary synchronization signal (primary synchronization signal, PSS) and secondary synchronization signal (secondary synchronization signal, SSS) configuration. The second participant node may perform physical time synchronization with the intra-network node 1 based on a PSS and an SSS. For example, after detecting a synchronization sequence, the second participant node may determine a location from which the intra-network node 1 starts to transmit a signal, and perform receiving and decoding from the position.

A second type is a broadcast information configuration, for example, including a current reference time indication (an indication such as a subframe number or a slot number). The second participant node may perform time synchronization with a system of the intra-network node 1 based on the broadcast information configuration. For example, the second participant node may maintain a same subframe number and slot number as the intra-network node 1 based on the broadcast information configuration. However, the intra-network node 1 and the first centralized node originally maintain a same subframe number and slot number. Therefore, all nodes in a management range of the first centralized node can also maintain a same subframe number and slot number.

After the second participant node receives the PSB, the second participant node may perform time synchronization with the intra-network node 1 by using time synchronization information included in the PSB. After the time synchronization, the second participant node may perform transmission of data or control signaling with the intra-network node 1.

For example, configuration information for reporting probing feedback (that is, configuration information for sending a preamble by the intra-network node) in the PSB may include at least one of a time domain resource configuration for feedback reporting, a preamble sequence set, and a threshold (optional) for feedback reporting on each time domain resource.

For example, a granularity of a time domain resource for feedback reporting may be a time unit such as a subframe, a slot, a frame, or a symbol. In the following examples, a slot is used as an example for description.

A slot configuration for feedback reporting indicates a slot used by the second participant node to report probing feedback information (that is, the preamble) to the intra-network node 1. For example, a plurality of slots (certainly, which may also be another time unit, for example, a subframe, a frame, or a symbol) may be configured. The second participant node may select, from a plurality of configured slots, one slot to send the preamble to the intra-network node 1 as the probing feedback information.

After each participant node in the bottleneck area 1 receives the PSB, each participant node may detect quality of a link between the participant node and the intra-network node 1, and determine, based on a slot for feedback reporting that is selected by the node, a threshold for feedback reporting in the slot from thresholds for feedback reporting in slots indicated by the PSB, and sends the preamble to the intra-network node 1 in the selected slot only when the quality of the link meets the threshold (for example, greater than or equal to the threshold). In this way, efficiency and a success rate of selecting a link between the intra-network node 1 and the participant node to transit data can be ensured, and normal data transmission can be ensured.

The preamble sequence set includes a plurality of preamble sequences, and one preamble sequence may be generated based on a root sequence and a cyclic shift. The second participant node may randomly select a preamble sequence as a preamble of the second participant node based on a preamble sequence set in the PSB.

Optionally, if there are a small quantity of participant nodes in the bottleneck area 1 (there are a small quantity of second participant nodes), the preamble sequence set may include a same root sequence of a plurality of preamble sequences. In this case, when blindly detecting a preamble sent by the second participant node, the intra-network node 1 needs to perform detection based on only one root sequence, so that efficiency of blindly detecting the preamble by the intra-network node 1 can be improved, and time used for blindly detecting the preamble can be reduced. If there are a large quantity of participant nodes in the bottleneck area 1 (there are a large quantity of second participant nodes), the preamble sequence set may include different root sequences of a plurality of preamble sequences. In this case, when blindly detecting a preamble sent by the second participant node, the intra-network node 1 may need to perform detection based on one root sequence or all possible root sequences.

After detecting preambles reported by different participant nodes, the intra-network node 1 may use an index (or an ID) of the detected preamble as an ID of a participant node that sends the preamble.

The following describes in detail a manner in which the participant node sends the preamble in S550.

Optionally, in a possible implementation, if all the foregoing nodes (for example, the participant node, the intra-network node, and the centralized node) are in a half-duplex configuration, after receiving the PSB, the participant node selects, based on an indication of the PSB and a probability, one slot from X configured slots (slot) to send the preamble as probing feedback information, and monitors, in another slot before the slot, a preamble sent by a surrounding participant node. If a slot selected by the participant node is a 1^{st} slot, the participant node needs to send only the preamble configured by the participant node; otherwise, the participant node needs to send the monitored preamble together with the preamble of the participant node in a superposition manner in the selected slot.

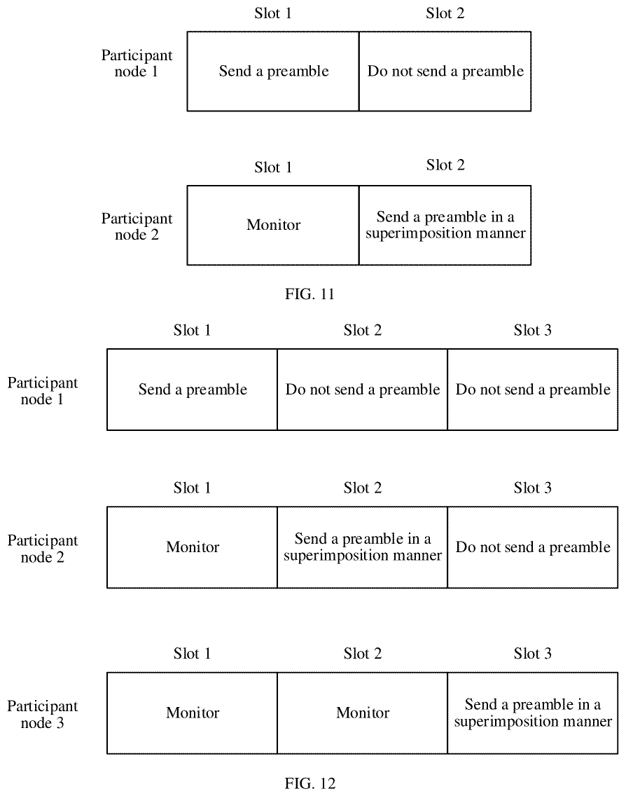

For example, as shown in FIG. 11, it is assumed that two feedback slots are configured for the PSB, which are respectively a slot 1 and a slot 2, and two participant nodes (a participant node 1 and a participant node 2) receive the PSB that is broadcast by the intra-network node 1. The participant node 1 chooses to send a preamble of the participant node 1 in the slot 1, and the participant node 2 chooses to send a preamble of the participant node 2 in the slot 2. In this case, the participant node 2 sends, in the slot 2 in a superimposition manner, a preamble monitored in the slot 1 and the preamble of the participant node 2. The preamble monitored by the participant node 2 in the slot 1 may include the preamble sent by the participant node 1 in the slot 1, and certainly, may further include a preamble that is of another participant node and that is sent by the another participant node in the slot 1.

For another example, as shown in FIG. 12, it is assumed that three feedback slots are configured for the PSB, which are respectively a slot 1, a slot 2, and a slot 3, and three participant nodes (a participant node 1, a participant node 2, and a participant node 3) receive the PSB that is broadcast by the intra-network node 1. The participant node 1 chooses to send a preamble of the participant node 1 in the slot 1, the participant node 2 chooses to send a preamble of the participant node 2 in the slot 2, and the participant node 3 chooses to send a preamble of the participant node 3 in the slot 3. In this case, the participant node 2 sends, in the slot 2 in a superimposition manner, a preamble monitored in the slot 1 (for example, including a preamble sent by the participant node in the slot 1) and a preamble of the participant node 2. The participant node 3 sends, in the slot 3 in a superimposition manner, a preamble monitored in the slot 1 (for example, including a preamble sent by the participant node in the slot 1), a preamble monitored in the slot 2 (for example, a preamble sent by the participant node in the slot 2), and a preamble of the participant node 3.

Optionally, in the examples shown in FIG. 11 and FIG. 12, the probing feedback information sent by the participant nodes may share a same frequency resource.

In a half-duplex working mode, a manner in which the participant node feeds back the preamble may enable the centralized node to efficiently and accurately obtain multi-hop topology information, so as to perform network structure reconstruction.

Optionally, in another possible implementation, if all the foregoing nodes (for example, the participant node, the intra-network node, and the centralized node) are in a full-duplex configuration, after receiving the PSB, any participant node (separately) sends, based on an indication of the PSB in first X-1 slots in X (X is greater than 1) configured slots, a preamble configured by the participant node, monitors a preamble sent by a surrounding participant node, and sends, in a last slot in the X slots in a superimposition manner, the preamble configured by the participant node and all monitored preambles.

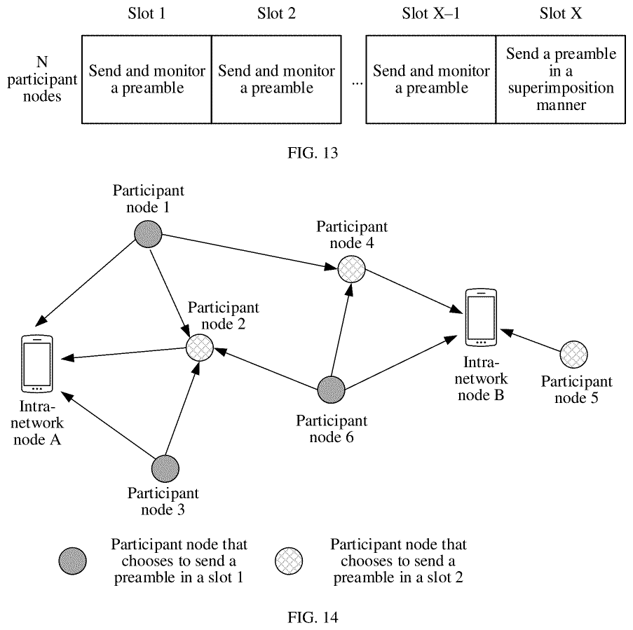

For example, as shown in FIG. 13, it is assumed that X feedback slots (slot) are configured for a PSB sent by an intra-network node 1, and there are N participant nodes in a bottleneck area 1. Each participant node (separately) sends, in first X-1 slots, a preamble configured by the participant nodes, monitors a preamble sent by a surrounding participant node, and sends, in a last slot in the X slots in a superposition manner, the preamble of the participant node and all preambles monitored in the first X-1 slots.

In a full-duplex working mode, a manner in which the participant node feeds back the preamble can improve efficiency of feeding back the preamble by the participant node, so that the centralized node can efficiently and accurately obtain multi-hop topology information, to perform network structure reconstruction.

The following describes, with reference to specific examples, a manner in which the intra-network node sends, to the first centralized node, an index of a preamble detected in each slot in S560.

It is assumed that each node (for example, a participant node, an intra-network node, and a centralized node) is in a half-duplex configuration. In a network topology structure shown in FIG. 14, there are two intra-network nodes: an intra-network node A and an intra-network node B. The intra-network node A and the intra-network node B each send a PSB. Two feedback slots, namely, a slot 1 and a slot 2, are configured in the PSB, and a same preamble sequence set is configured in the two PSBs. There are six participant nodes (participant nodes 1 to 6). The participant node 1, the participant node 2, and participant node 3 can directly communicate with the intra-network node A, and the participant node 6 can communicate with the intra-network node A only through transit (relay) of the participant node 2. The participant node 4, the participant node 5, and the participant node 6 can directly communicate with the intra-network node B, and the participant node 1 can communicate with the intra-network node B only through transit (relay) of the participant node 4.

In the network architecture shown in FIG. 14, the participant node 1, the participant node 2, the participant node 3, and the participant node 6 may detect a PSB that is broadcast by the intra-network node A. The participant node 1, the participant node 4, the participant node 6, and the participant node 5 may detect a PSB that is broadcast by the intra-network node B. The participant node 1, the participant node 3, and the participant node 6 choose to send a preamble in the slot 1, and the participant node 2, the participant node 4, and the participant node 5 choose to send a preamble in the slot 1. In addition, IDs of the preambles sent by the participant node 1 to the participant node 6 are used as IDs of the participant nodes, that is, the ID of the preamble is used to identify the ID of the participant node. It is assumed that a preamble ID of the participant node 1 is 1, a preamble ID of the participant node 2 is 2, a preamble ID of the participant node 3 is 3, a preamble ID of the participant node 4 is 4, a preamble ID of the participant node 5 is 5, and a preamble ID of the participant node 6 is 6.

In the scenario shown in FIG. 14, for the intra-network node A:

In the slot 1, IDs of received (detected) preambles are respectively 1 and 3, that is, the intra-network node A receives, in the slot 1, preambles respectively sent by the participant node 1 and the participant node 3, and IDs of the detected preambles are respectively 1 and 3. Optionally, the participant node 1 may further send, to the intra-network node A in the preamble, quality d1-A of a link between the participant node 1 and the intra-network node A, for example, d_{1-A}=10 dB. The participant node 3 may also send, to the intra-network node A in the preamble, quality d_{3-A} of a link between the participant node 3 and the intra-network node A, for example, d3-A=15 dB. It should be understood that, although the participant node 6 also chooses to send the

preamble in the slot 1, because a distance between the participant node 6 and the intra-network node A is long, signal strength of the preamble sent by the participant node 6 is weak, and the intra-network node detects that the preamble has a signal strength threshold. After the signal strength of the preamble is less than a threshold, the intra-network node cannot detect the preamble. Therefore, although the participant node 6 also chooses to send the preamble in the slot 1, signal strength of the preamble is weak, and the intra-network node A cannot detect the preamble.

In the slot 2, because the participant node 2 monitors, in the slot 1, the preambles respectively sent by the participant node 1, the participant node 3, and the participant node 6, in the slot 2, the participant node 2 may superimpose the preambles respectively sent by the participant node 1, the participant node 3, and the participant node 6 and the preamble of the participant node 2 (the participant node 2) that are monitored in the slot 1, and send the preambles to the intra-network node A. That is, the intra-network node A detects, in the slot 2, the preambles respectively corresponding to the participant node 1, the participant node 3, the participant node 6, and the participant node 2. In other words, IDs of the preambles detected by the intra-network node A in the slot 2 are respectively 1, 2, 3, and 6.

Optionally, the participant node 2 may further send, to the intra-network node A in the preamble, quality d_{2-A} of a link between the participant node 2 and the intra-network node A, for example, d_{2-A}=18 dB.

In this way, the intra-network node A may send, to the first centralized node, the ID of the preamble detected in each slot and the link quality (the link quality is optional).

For example, Table 1 is a schematic table of an index of a preamble detected by the intra-network node A in each slot and link quality in the foregoing example. The intra-network node A may send content shown in Table 1 to the first centralized node.

TABLE 1

| | Slot 1 | | Slot 2 | |
|---|---|---|---|---|
| Intra- | ID of a | | ID of a | |
| network | detected | Link | detected | Link |
| node | preamble | quality | preamble | quality |
| A | 1 and 3 | d_{1-A} = 10 dB | 1, 2, 3, and 6 | d_{2-A} = 18 dB |
| | | d_{3-A} = 15 dB | | |

In the foregoing scenario, for the intra-network node B:

In the slot 1, the ID of the received preamble is 6, that is, the intra-network node B receives, in the slot 1, a preamble sent by the participant node 6, and the ID of the detected preamble is 6. Optionally, the participant node 6 may further send, to the intra-network node B in the preamble, quality d_{6-B} of a link between the participant node 6 and the intra-network node B, for example, d_{6-B}=10 dB.

It should be understood that, although the participant node 1 also chooses to send the preamble in the slot 1, because a distance between the participant node 1 and the intra-network node B is long, signal strength of the preamble sent by the participant node 1 is weak, and the intra-network node detects that the preamble has a signal strength threshold. After the signal strength of the preamble is less than a threshold, the intra-network node cannot detect the preamble. Therefore, although the participant node 1 also chooses to send the preamble in the slot 1, signal strength of the preamble is weak, and the intra-network node B cannot detect the preamble.

For the participant node 4, because the participant node 4 monitors, in the slot 1, the preambles respectively sent by the participant node 1 and the participant node 6, in the slot 2, the participant node 4 may superimpose the preambles respectively sent by the participant node 1 and the participant node 6 and the preamble of the participant node 4 (the participant node 4) that are monitored in the slot 1, and send the preambles to the intra-network node A. For the participant node 5, because the participant node 5 does not monitor, in the slot 1, a preamble sent by another participant node, in the slot 2, the participant node 5 sends a preamble of the participant node 5 (the participant node 5) to the intra-network node B. That is, the intra-network node B detects, in the slot 2, the preambles respectively corresponding to the participant node 1, the participant node 4, the participant node 6, and the participant node 5. In other words, IDs of the preambles detected by the intra-network node B in the slot 2 are respectively 1, 4, 6, and 5.

Optionally, the participant node 4 may further send, to the intra-network node B in the preamble, quality d_{4-B} of a link between the participant node 4 and the intra-network node B, for example, d_{4-B}=15 dB. The participant node 5 may further send, to the intra-network node B in the preamble, quality d_{5-B} of a link between the participant node 5 and the intra-network node B, for example, d_{5-B}=10 dB.

In this way, the intra-network node B may send, to the first centralized node, the ID of the preamble detected in each slot and the link quality (the link quality is optional).

For example, Table 2 is a schematic table of an index of a preamble detected by the intra-network node B in each slot and link quality in the foregoing example. The intra-network node B may send content shown in Table 2 to the first centralized node.

TABLE 2

| | Slot 1 | | Slot 2 | |
|---|---|---|---|---|
| Intra- | ID of a | | ID of a | |
| network | detected | Link | detected | Link |
| node | preamble | quality | preamble | quality |
| B | 6 | d_{6-B} = 18 dB | 1, 4, 6, and 5 | d_{4-B} = 15 dB |
| | | | | d_{5-B} = 10 dB |

S570: The first centralized node determines multi-hop network topology information based on the index of the preamble that is detected in each slot and that is reported by each intra-network node.

S580: The first centralized node performs network structure reconstruction based on the multi-hop network topology information.

Wi^{th} reference to the example shown in FIG. 14, it is assumed that intra-network nodes

that are included in all bottleneck areas in the first network and that are managed by the first centralized node are the intra-network node A and the intra-network node B, and the intra-network node A and the intra-network node B may belong to a same bottleneck area, or may belong to different bottleneck areas. In addition, participant nodes that are in all the bottleneck areas and that are managed by the second centralized node are the foregoing participant node 1 to participant node 6. In this case, index information of the preamble that is detected in each slot and that is received by the first centralized node and link quality information may be shown in Table 3.

TABLE 3

| | Slot 1 | | Slot 2 | |
|---|---|---|---|---|
| Intra- | ID of a | | ID of a | |
| network | detected | Link | detected | Link |
| node | preamble | quality | preamble | quality |
| A | 1 and 3 | d_{1-A} = 10 dB | 1, 2, 3, and 6 | d_{2-A} = 18 dB |
| | | d_{3-A} = 15 dB | | |
| B | 6 | d_{6-B} = 18 dB | 1, 4, 6, and 5 | d_{4-B} = 15 dB |
| | | | | d_{5-B} = 10 dB |

The first centralized node may determine the multi-hop network topology information based on the index of the preamble that is detected in each slot and that is reported by each intra-network node.

For example, with reference to the example shown in Table 3, for each intra-network node, the first centralized node may determine a one-hop participant node and a two-hop participant node of the intra-network node in the following manner. In a possible implementation, for each intra-network node, the centralized node lists,

as a one-hop participant node, a node ID corresponding to a preamble received in a 1^{st} slot (the slot 1). Based on a time domain spectrum peak corresponding to a preamble received in a 2^{nd} slot (slot 2), each intra-network node finds a time domain spectrum peak with a unique height, and adds a node ID corresponding to the time domain spectrum peak to a one-hop participant node; then finds a plurality of time domain spectrum peaks with a same height, and uses preambles corresponding to the plurality of time domain spectrum peaks with the same height as a set (for ease of partitioning, referred to as a first set); checks whether the intra-network node has detected a preamble in the first set in the 1^{st} slot, and if the intra-network node has detected the preamble, deletes the preamble from the first set, where a set formed by remaining preambles obtained after the preamble is deleted is referred to as a second set; and checks whether another intra-network node has detected a preamble in the second set in the 1^{st} slot, and if the another intra-network node has detected the preamble, lists a node ID corresponding to the preamble as a two-hop participant node, deletes the preamble from the second set, and adds a node corresponding to a remaining preamble in the second set as a one-hop participant node of the intra-network node. Finally, the participant node further supplements the multi-hop topology information based on a neighboring node of the participant node, and finally obtains topology information of a one-hop, two-hop, or multi-hop participant node around the intra-network node and corresponding link channel quality.

For example, the intra-network node A lists a node ID corresponding to the preamble received in the slot 1 as a one-hop participant node of the intra-network node A, that is, the one-hop participant node includes the participant node 1 and the participant node 3; and determines a time domain spectrum peak with a unique height based on time domain spectrum peaks respectively corresponding to preambles received in the slot 2, and adds a participant node ID corresponding to the time domain spectrum peak to the one-hop participant node. The preambles received in the slot 2 are respectively a preamble 1 of the participant node 1, a preamble 2 of the participant node 2, a preamble 3 of the participant node 3, and a preamble 6 of the participant node 6. Because all the preambles received in the slot 2 are sent by the participant node 2 to the intra-network node A, the time domain spectrum peaks respectively corresponding to the four preambles received in the slot 2 are the same, and therefore, a preamble corresponding to the time domain spectrum peak with the unique height is empty, that is, there is no time domain spectrum peak with a unique height. Then, the intra-network node A finds a plurality of spectrum peaks of a same height, and uses preambles corresponding to the plurality of time domain spectrum peaks of the same height as a set (that is, a first set), where the first set includes {preamble 1, preamble 2, preamble 3, preamble 6}. The intra-network node A checks whether the intra-network node A has detected a preamble in the first set in the 1^{st} slot, and if the intra-network node A has detected the preamble, deletes the preamble from the first set to obtain a second set. Because the intra-network node A has detected the preamble 1 and the preamble 3 in the first set in the 1^{st} slot, the second set includes {preamble 2, preamble 6}. The intra-network node A checks whether another intra-network node (that is, the intra-network node B) has detected a preamble in the second set in the 1^{st} slot, and if the another intra-network node has detected the preamble, lists a node ID corresponding to the preamble as a two-hop participant node of the intra-network node A. Because the intra-network node B has detected the preamble 6 in the second set in the 1^{st} slot, the participant node 6 corresponding to the preamble 6 is listed as a two-hop participant node of the intra-network node A. Then, the preamble 6 is deleted from the second set, and a participant node corresponding to a remaining preamble in the second set (the remaining preamble is the preamble 2, and corresponds to the participant node 2) is added as a one-hop participant node of the intra-network node A. In this case, the one-hop participant node of the intra-network node A includes a participant node 1, a participant node 2, and a participant node 3. The two-hop participant node of the intra-network node A includes a participant node 6.

Further, the intra-network node A detects, in a 2^{nd} slot (the slot 2), four preamble signals with a same spectrum peak height, which are respectively preambles sent by the participant node 1, the participant node 2, the participant node 3, and the participant node 6. It can be learned from Table 3 that, in the slot 1, the participant node 1, the participant node 3, and the participant node 6 have sent the preamble. Therefore, the participant node 1, the participant node 3, and the participant node 6 do not send the preamble again in the slot 2, that is, the three participant nodes remain silent in the slot 2. However, the intra-network node A still detects preambles of the participant node 1, the participant node 3, and the participant node 6 in the slot 2, because the participant node 2 sends the preamble in the slot 2, and sends the monitored preambles that are respectively sent by the participant node 1, the participant node 3, and the participant node 6 in the slot 1 together. Therefore, it may be determined that the participant node 1, the participant node 3, and the participant node 6 are all within a one-hop range of the participant node 2. In addition, if the intra-network node A detects (in the slot 1) the preambles respectively sent by the participant node 1 and the participant node 3, it indicates that both the participant node 1 and the participant node 3 are within a one-hop range of the intra-network node A. The participant node 6 is far away from the intra-network node A, and the preamble sent by the participant node 6 cannot be detected by the intra-network node A, but the preamble sent by the participant node 6 can be detected by the participant node 2. In this case, it indicates that the participant node 6 is within a one-hop range of the participant node 2, and the participant node 2 is in a one-hop range of the intra-network node A. Therefore, a two-hop participant node of the intra-network node A includes the participant node 6, and the participant node 6 is connected to the intra-network node A through transit (relay) of the participant node 2.

It can be learned from Table 3 that, if the intra-network node B detects the preamble of the participant node 6 in a 1^{st} slot (the slot 1), it indicates that the participant node 6 is within a one-hop range of the intra-network node B, and the participant node 6 is also a two-hop participant node of the intra-network node A. In this case, it may be determined that a three-hop destination node of the intra-network node A is the intra-network node B.

For example, Table 4 shows an example of multi-hop network topology information that is of the intra-network node A and that is determined by the first centralized node.

TABLE 4

| Intra- | | | Three-hop |
|---|---|---|---|
| network | ID of a one-hop | ID of a two-hop | destination |
| node | participant node | participant node | node |
| A | 1, 2, and 3 | 6 (through transit of 2) | B |

For example, the intra-network node B lists a node ID corresponding to the preamble received in the slot 1 as a one-hop participant node of the intra-network node A, that is, the one-hop participant node includes the participant node 6; and determines a time domain spectrum peak with a unique height based on time domain spectrum peaks respectively corresponding to preambles received in the slot 2, and adds a participant node ID column corresponding to the time domain spectrum peak to the one-hop participant node. The preambles received in the slot 2 are respectively preambles of the participant node 1, the participant node 4, the participant node 6, and the participant node 5. Preambles sent by the participant node 4 in the slot 2 include a preamble 1 of the participant node 1, a preamble 4 of the participant node 4, and a preamble 6 of the participant node 6. All the three preambles are sent by the participant node 4 to the intra-network node B. Therefore, heights of time domain spectrum peaks respectively corresponding to the three preambles are the same. A height of a time domain spectrum peak corresponding to the preamble 5 sent by the participant node 5 in the slot 2 is different from the heights of the time domain spectrum peaks of the foregoing three preambles, and a preamble corresponding to the time domain spectrum peak with the unique height is the preamble 5. The intra-network node B adds a column of the participant node 5 corresponding to the preamble 5 to a one-hop participant node. Then, the intra-network node B finds a plurality of spectrum peaks of a same height, and uses preambles corresponding to the plurality of time domain spectrum peaks of the same height as a set (that is, a first set), where the first set includes {preamble 1, preamble 4, preamble 6}. The intra-network node B checks whether the intra-network node B has detected a preamble in the first set in the 1 st slot, and if the intra-network node B has detected the preamble, deletes the preamble from the first set to obtain a second set. Because the intra-network node B has detected the preamble 6 in the first set in the 1^{st} slot, the second set includes {preamble 1, preamble 4}. The intra-network node B checks whether another intra-network node (that is, the intra-network node A) has detected a preamble in the second set in the 1^{st} slot, and if the another intra-network node has detected the preamble, lists a node ID corresponding to the preamble as a two-hop participant node of the intra-network node A. Because the intra-network node A has detected the preamble 1 in the second set in the 1^{st} slot, the participant node 1 corresponding to the preamble 1 is listed as a two-hop participant node of the intra-network node B. Then, the preamble 1 is deleted from the second set, and a participant node corresponding to a remaining preamble in the second set (the remaining preamble is the preamble 4, and corresponds to the participant node 4) is added as a one-hop participant node of the intra-network node B. In this case, the one-hop participant node of the intra-network node B includes a participant node 4, a participant node 5, and a participant node 6. The two-hop participant node of the intra-network node B includes a participant node 1.

Further, the intra-network node B detects, in a 2^{nd} slot (the slot 2), three preamble signals with a same spectrum peak height, which are respectively preambles sent by the participant node 1, the participant 4, and the participant node 6. In addition, the intra-network node B has determined that the participant node 5 is a one-hop participant node of the intra-network node B. It can be learned from Table 3 that, in the slot 1, the participant 1 and the participant node 6 have sent the preamble. Therefore, the participant node 1 and the participant node 6 do not send the preamble again in the slot 2, that is, the two participant nodes remain silent in the slot 2. However, the intra-network node B still detects preambles of the participant 1 and the participant node 6 in the slot 2, because the participant node 4 sends the preamble in the slot 2, and sends the monitored preambles that are respectively sent by the participant node 1 and the participant node 6 in the slot 1 together. Therefore, it may be determined that the participant node 1 and the participant node 6 are both within a one-hop range of the participant node 4. In addition, if the intra-network node B detects (in the slot 1) the preamble sent by the participant node 6, it indicates that the participant node 6 is within a one-hop range of the intra-network node B. The participant node 1 is far away from the intra-network node B, and the preamble sent by the participant node 1 cannot be detected by the intra-network node B, but the preamble sent by the participant node 1 can be detected by the participant node 4. In this case, it indicates that the participant node 1 is within a one-hop range of the participant node 4, and the participant node 4 is in a one-hop range of the intra-network node B. Therefore, a two-hop participant node of the intra-network node B includes the participant node 1, and the participant node 1 is connected to the intra-network node B through transit (relay) of the participant node 4.

It can be learned from Table 3 that, if the intra-network node A detects the preamble of the participant node 1 in a 1^{st} slot (the slot 1), it indicates that the participant node 1 is within a one-hop range of the intra-network node A, and the participant node 1 is also a two-hop participant node of the intra-network node B. In this case, it may be determined that a three-hop destination node of the intra-network node B is the intra-network node A.

For example, Table 5 shows an example of multi-hop network topology information that is of the intra-network node B and that is determined by the first centralized node.

TABLE 5

| Intra- | | | Three-hop |
|---|---|---|---|
| network | ID of a one-hop | ID of a two-hop | destination |
| node | participant node | participant node | node |
| B | 4, 5, and 6 | 1 (through transit of 4) | A |

For example, after the first centralized node obtains information about the one-hop participant node and the two-hop participant node of the intra-network node A, and information about the one-hop participant node and the two-hop participant node of the intra-network node B, because the two-hop participant node of the intra-network node A is the one-hop participant node of the intra-network node B, it may be determined that the three-hop destination node of the intra-network node A is the intra-network node B. Because the two-hop participant node of the intra-network node B is the one-hop participant node of the intra-network node A, it may be determined that the three-hop destination node of the intra-network node B is the intra-network node A.

In the foregoing examples, Table 6 may show that the first centralized node determines the multi-hop network topology information based on indexes of preambles that are detected in each slot and that are respectively reported by the intra-network node A and the intra-network node B.

TABLE 6

| Intra- | | | Three-hop |
|---|---|---|---|
| network | ID of a one-hop | ID of a two-hop | destination |
| node | participant node | participant node | node |
| A | 1, 2, and 3 | 6 (through transit of 2) | B |
| B | 4, 5, and 6 | 1 (through transit of 4) | A |

After obtaining the information shown in Table 6, the first centralized node may determine the multi-hop network topology information. For example, the multi-hop network topology information may include each participant node added to a network, a network topology relationship between participant nodes, a newly added sidelink, and service data flow information (for example, a local rerouting path of each data flow and a rate allocated to each data flow). Then, the first centralized node may send the multi-hop network topology information to each intra-network node through a Uu interface, for example, send the multi-hop network topology information to each intra-network node by using RRC signaling, and each intra-network node implements network structure reconstruction, thereby finally breaking through a network bottleneck and greatly improving a network throughput.

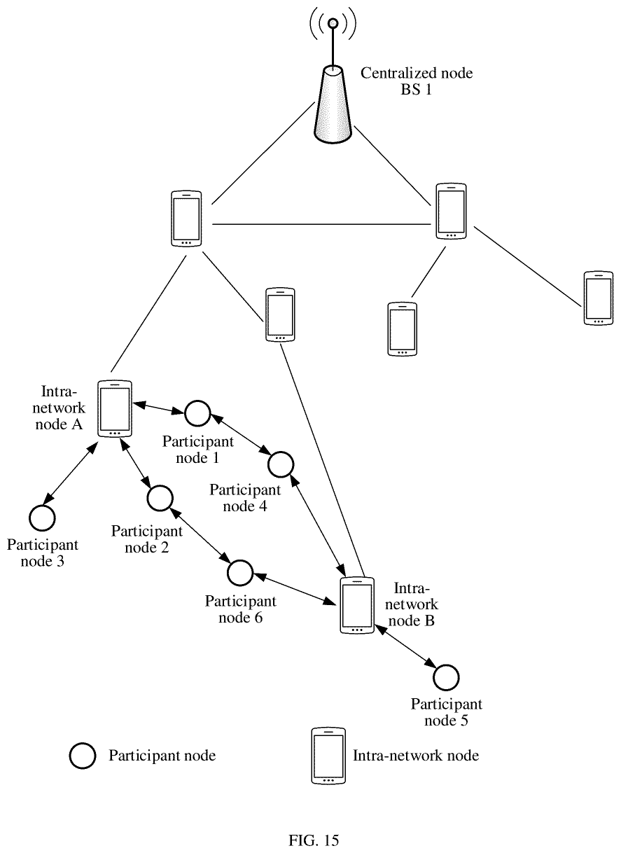

For example, with reference to the example shown in FIG. 14, a structure obtained through network structure reconstruction is shown in FIG. 15. A one-hop participant node of the intra-network node A includes a participant node 1, a participant node 2, and a participant node 3. A two-hop participant node of the intra-network node A includes a participant node 6 (through transit of the participant node 2). A three-hop destination node of the intra-network node A is the intra-network node B. A one-hop participant node of the intra-network node B includes a participant node 4, a participant node 5, and a participant node 6. A two-hop participant node of the intra-network node B includes a participant node 1 (through transit of the participant node 4). A three-hop destination node of the intra-network node B is the intra-network node A.

According to the communication system and method provided in this application, for a wireless mesh network architecture, a bottleneck message is exchanged between the centralized nodes, to provide strong support for probing participant nodes in an idle/inactive state in different networks. In addition, the active time information of the participant node is requested and responded between the centralized nodes, so that the probing information block sent by the intra-network node can be efficiently received by the participant node. The centralized node configures the time-frequency resource of the probing information block or configures the candidate resource of the time-frequency resource of the probing information block, thereby improving flexibility of resource allocation, and improving efficiency of discovering a surrounding participant node. The participant node feeds back the preamble in a half-duplex or full-duplex mode as the probing feedback information, so that the centralized node can efficiently and accurately obtain the multi-hop topology information, select, based on a requirement for improvement in overall network performance, an appropriate participant node to join a network, reestablish a wireless link, and perform network structure reconstruction, thereby finally breaking through a network bottleneck and greatly improving a network throughput.

It should be understood that the foregoing descriptions are merely intended to help a person skilled in the art better understand embodiments of this application, but are not intended to limit the scope of embodiments of this application. It is clear that a person skilled in the art may make various equivalent modifications or changes based on the foregoing examples. For example, some steps in the foregoing method embodiments may be unnecessary, or some steps may be newly added. Alternatively, any two or more of the foregoing embodiments are combined. A modified, changed, or combined solution also falls within the scope of the embodiments of this application.

It should be further understood that division of manners, cases, categories, and embodiments in embodiments of this application is merely intended for ease of description, and should not constitute a particular limitation. The features in the manners, categories, cases, and embodiments may be combined without contradiction.

It should be further understood that numerals used in embodiments of this application are merely distinguished for ease of description, but are not intended to limit the scope of embodiments of this application. The sequence numbers of the foregoing processes do not mean execution sequences. The execution sequences of the processes should be determined based on functions and internal logic of the processes, and should not constitute any limitation on implementation processes of embodiments of this application.

It should be further understood that the foregoing descriptions of the embodiments of this application emphasize differences between the embodiments. For same or similar parts that are not mentioned, refer to the embodiments. For brevity, details are not described herein again.

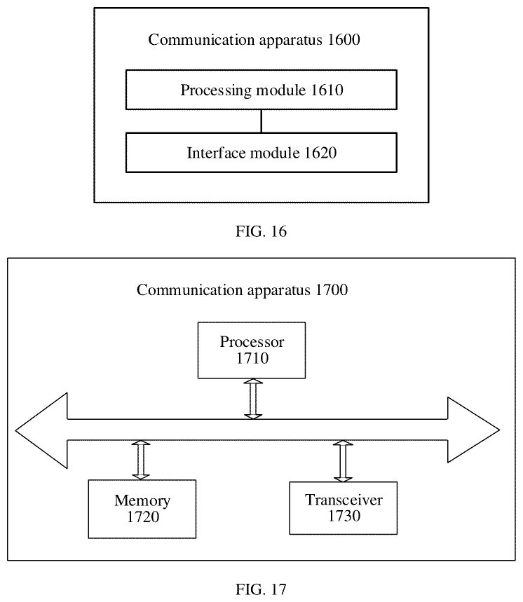

The foregoing describes in detail methods in embodiments of this application with reference to FIG. 1 to FIG. 15. The following describes in detail communication apparatuses in embodiments of this application with reference to FIG. 16 to FIG. 20.

In embodiments, the centralized node (including the first centralized node and the second centralized node), the intra-network node, and the participant node (including the second participant node) may be divided into functional modules according to the foregoing method. For example, each functional module may be obtained through division based on each corresponding function, or two or more functions may be integrated into one processing module. The integrated module may be implemented in a form of hardware. It should be noted that division into the modules in this embodiment is an example and is merely logical function division, and may be other division in an actual implementation.

It should be noted that related content of the steps in the foregoing method embodiments may be referenced to function descriptions of corresponding function modules, and details are not described herein again.

The centralized node, the intra-network node, and the participant node provided in embodiments of this application are configured to perform any communication method according to the foregoing method embodiments, and therefore can achieve a same effect as the foregoing implementation method. When an integrated unit is used, the centralized node, the intra-network node, or the participant node may include a processing module, a storage module, and a communication module. The processing module may be configured to: control and manage actions of the centralized node, the intra-network node, or the participant node. For example, the processing module may be configured to support the centralized node, the intra-network node, or the participant node in performing steps performed by the processing unit. The storage module may be configured to support storage of program code, data, and the like. The communication module may be configured to support communication between the centralized node, the intra-network node, or the participant node and another device.

The processing module may be a processor or a controller. The processor may implement or perform various examples of logic blocks, modules, and circuits described with reference to content disclosed in this application. The processor may alternatively be a combination for implementing a computing function, for example, a combination including one or more microprocessors or a combination of a digital signal processor (digital signal processor, DSP) and a microprocessor. The storage module may be a memory. The communication module may be specifically a device, for example, a radio frequency circuit, a Bluetooth chip, or a Wi-Fi chip, that interacts with another electronic device.

For example, FIG. 16 is a block diagram of a communication apparatus 1600 according to an embodiment of this application. The communication apparatus 1600 may correspond to the centralized node (for example, the first centralized node or the second centralized node) described in the foregoing method 500, or may be a chip or a component used in the centralized node. In addition, modules or units in the communication apparatus 1600 are separately configured to perform actions or processing processes performed by the first centralized node or the second centralized node in the foregoing method 500.

As shown in FIG. 16, the communication apparatus 1600 may include a processing module 1610 and an interface module 1620. The interface module 1620 is configured to perform specific signal receiving and sending under driving of the processing module 1610.

In some embodiments, details are as follows:

The interface module 1620 is configured to send indication information to at least one second node, where the indication information indicates the second node to send a probing information block, and the at least one second node is a node for which the first node performs configuration indication.

The interface module 1620 is further configured to receive first information respectively sent by the at least one second node, where the first information includes a preamble, in response to the probing information block, that is sent by a third node and that is detected in each time unit.

The processing module 1610 is configured to determine multi-hop network topology information based on the first information respectively fed back by the at least one intra-network node.

According to the communication apparatus provided in this embodiment of this application, for a wireless mesh network architecture, uplink and downlink multi-hop links and multi-hop sidelinks between users are considered. Each intra-network node (the second node) probes, under coordination of a centralized node (the first node), a participant node (the third node) in an idle/inactive state, obtains topology information of a multi-hop participant node, selects, based on a requirement for improvement in overall network performance, an appropriate participant node to join a network, reestablishes a wireless link, and performs network structure reconstruction, to finally break through a network bottleneck and greatly improve a network throughput.

In some possible implementations, the indication information includes time-frequency resource configuration information for sending the probing information block.

In some possible implementations, the participant node is a node in an idle/inactive state in a network.

In some possible implementations, the at least one second node is located in a bottleneck area, the bottleneck area is a bottleneck area that is in a first network and that is managed by the first node, and the bottleneck area includes a plurality of third nodes.

In some possible implementations, the third node is a node for which a fourth node (the fourth node may also be referred to as a second centralized node) performs configuration indication, and the indication information includes time-frequency resource configuration information for sending the probing information block. Before the first centralized node separately sends the indication information to the at least one intra-network node in the bottleneck area, the interface module 1620 is further configured to: send bottleneck request information to the second centralized node, where the bottleneck request information includes location information of the bottleneck area and expected active time information of the participant node in the bottleneck area; and receive bottleneck request response information from the second centralized node, where the bottleneck request response information includes active time information of the participant node in the bottleneck area, the active time information includes active time range and active time periodicity configuration information, and the participant node is a node in an idle or inactive state in a second network.

The processing module 1610 is configured to determine, based on the bottleneck request response information, a time domain resource for sending the probing information block.

In some possible implementations, the participant node is a node for which the communication apparatus performs configuration indication (that is, the third node is a node managed by the first node), and the processing module 1610 may independently determine active time information of the third node, so that the active time information of the third node does not need to be obtained through other signaling interaction, thereby reducing signaling resource overheads.

In some possible implementations, active time that is of the second participant node and that is included in the bottleneck request response information and the time domain resource for sending the probing information block at least partially overlap.

In some possible implementations, the time-frequency resource configuration information for the probing information block includes the time-frequency resource occupied for sending the probing information block.

In some possible implementations, the time-frequency resource configuration information for the probing information block includes configuration information of a first resource pool and configuration information of a plurality of candidate resources in the first resource pool, and the time-frequency resource occupied by the probing information block is one of the plurality of candidate resources.

In some possible implementations, the probing information block includes a primary synchronization sequence and a secondary synchronization sequence, current reference time indication information, configuration information for sending a preamble by the participant node, and an identifier of the intra-network node. The configuration information for sending the preamble by the participant node includes a time domain resource configuration for sending the preamble by the participant node, a threshold for sending the preamble by the participant node, and a preamble sequence set. The preamble sequence set includes a root sequence and a cyclic shift manner.

It should be understood that, for a specific process of performing the foregoing corresponding steps by the units in the communication apparatus 1600, refer to related descriptions of the first centralized node or the second centralized node in the foregoing related embodiments of the method 500. For brevity, details are not described herein again.

Optionally, the interface module 1620 may include a receiving unit (module) and a sending unit (module), configured to perform steps of receiving information and sending information by the first centralized node or the second centralized node in the embodiments of the foregoing method 500.

Further, the communication apparatus 1600 may further include a storage unit. The interface module 1620 may be a transceiver, an input/output interface, or an interface circuit. The storage unit is configured to store instructions executed by the interface module 1620 and the processing module 1610. The interface module 1620, the processing module 1610, and the storage unit are coupled to each other. The storage unit stores the instructions. The processing module 1610 is configured to execute the instructions stored in the storage unit. The interface module 1620 is configured to perform specific signal receiving and sending under driving of the processing module 1610.

It should be understood that the interface module 1620 may be the transceiver, the input/output interface, or the interface circuit. The storage unit may be a memory. The processing module 1610 may be implemented by a processor. As shown in FIG. 17, a communication apparatus 1700 may include a processor 1710, a memory 1720, and a transceiver 1730.

The communication apparatus 1600 shown in FIG. 16 or the communication apparatus 1700 shown in FIG. 17 can implement the steps performed by the first centralized node or the second centralized node in the embodiment of the foregoing method 500. For similar descriptions, refer to the descriptions in the foregoing corresponding methods. To avoid repetition, details are not described herein again.

It should be further understood that the communication apparatus 1600 shown in FIG. 16 or the communication apparatus 1700 shown in FIG. 17 may be a network device, or the network device may include the communication apparatus 1600 shown in FIG. 16 or the communication apparatus 1700 shown in FIG. 17.

It should be further understood that the network device in this application may alternatively be a chip, a chip system, or a processor that supports the network device in implementing the method, or may be a logical node, a logical module, or software that can implement all or some functions of the network device.

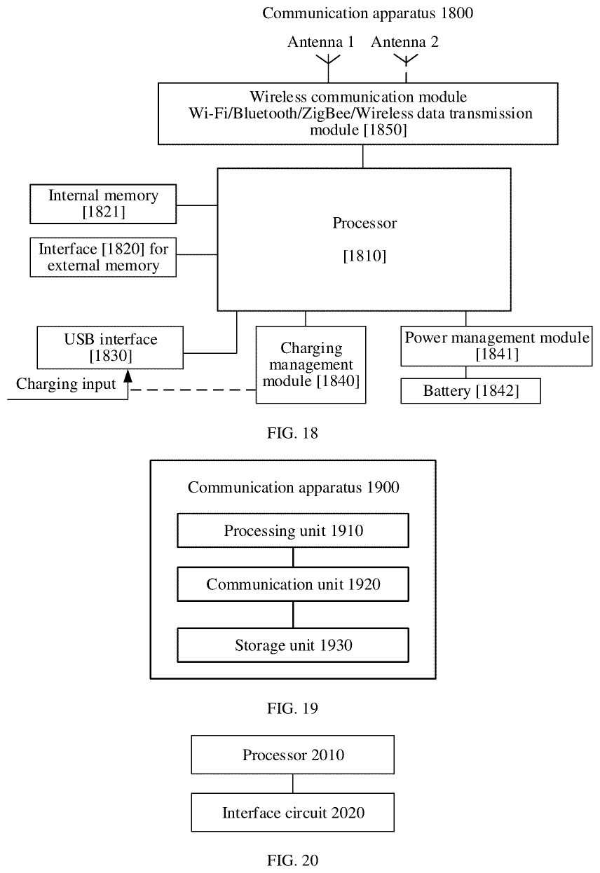

For example, FIG. 18 is a diagram of a hardware structure of an example of a communication apparatus 1800 according to this application. The communication apparatus 1800 may be the intra-network node or the participant node, or the intra-network node or the participant node may include the communication apparatus 1800.

As shown in FIG. 18, the communication apparatus 1800 may include a processor 1810, an interface 1820 for external memory, an internal memory 1821, a universal serial bus (universal serial bus, USB) interface 1830, a charging management module 1840, a power management module 1841, a battery 1842, an antenna 1, an antenna 2, a wireless communication module 1850, and the like.

It may be understood that, the structure shown in embodiments of this application does not constitute a specific limitation on the communication apparatus 1800. In some other embodiments of this application, the communication apparatus 1800 may include more or fewer components than those shown in the figure, or combine some components, or split some components, or have different component arrangements. The components shown in the figure may be implemented by hardware, software, or a combination of software and hardware.

For example, when the communication apparatus 1800 is a mobile phone, the communication apparatus may further include a display.

The processor 1810 may include one or more processing units. For example, the processor 1810 may include an application processor (application processor, AP), a modem processor, a graphics processing unit (graphics processing unit, GPU), an image signal processor (image signal processor, ISP), a controller, a video codec, a digital signal processor (digital signal processor, DSP), a baseband processor, and/or a neural-network processing unit (neural-network processing unit, NPU). Different processing units may be independent components, or may be integrated into one or more processors. In some embodiments, the communication apparatus 1800 may alternatively include one or more processors 1810. The controller may generate an operation control signal based on instruction operation code and a time sequence signal, to complete control of instruction reading and instruction execution.

In some embodiments, the processor 1810 may include one or more interfaces. The interface may include an inter-integrated circuit (inter-integrated circuit, I2C) interface, an inter-integrated circuit sound (integrated circuit sound, I2S) interface, a pulse code modulation (pulse code modulation, PCM) interface, a universal asynchronous receiver/transmitter (universal asynchronous receiver/transmitter, UART) interface, a mobile industry processor interface (mobile industry processor interface, MIPI), a general-purpose input/output (general-purpose input/output, GPIO) interface, a SIM card interface, a USB interface, and/or the like. The USB interface 1830 is an interface that conforms to a USB standard specification, and may be specifically a mini USB interface, a micro USB interface, a USB Type-C interface, or the like. The USB interface 1830 may be configured to connect to a charger to charge the communication apparatus 1800, or may be configured to transmit data between the communication apparatus 1800 and a peripheral device.

It may be understood that, an interface connection relationship between the modules shown in embodiments of this application is merely an example for description, and does not constitute a limitation on the structure of the communication apparatus 1800. In some other embodiments of this application, the communication apparatus 1800 may alternatively use an interface connection manner different from an interface connection manner in the foregoing embodiment, or a combination of a plurality of interface connection manners.

A wireless communication function of the communication apparatus 1800 may be implemented through the antenna 1, the antenna 2, the wireless communication module 1850, and the like.

The wireless communication module 1850 may provide a wireless communication solution that is applied to the communication apparatus 1800 and that includes Wi-Fi (including Wi-Fi awareness and Wi-Fi AP), Bluetooth (Bluetooth, BT), and a wireless data transmission module (for example, 433 MHz, 868 MHz, and 18118 MHz). The wireless communication module 1850 may be one or more components integrating at least one communication processing module. The wireless communication module 1850 receives an electromagnetic wave through the antenna 1 or the antenna 2 (or the antenna 1 and the antenna 2), performs filtering and frequency modulation processing on an electromagnetic wave signal, and sends a processed signal to the processor 1810. The wireless communication module 1850 may further receive a to-be-sent signal from the processor 1810, perform frequency modulation and amplification on the to-be-sent signal, and convert the to-be-sent signal into an electromagnetic wave for radiation through the antenna 1 or the antenna 2.

The interface 1820 for external memory may be configured to connect to an external storage card, for example, a micro SD card, to extend a storage capability of the communication apparatus 1800. The external memory card communicates with the processor 1810 through the interface 1820 for external memory, to implement a data storage function. For example, files such as music and videos are stored in the external storage card.

The internal memory 1821 may be configured to store one or more computer programs, and the one or more computer programs include instructions. The processor 1810 may run the instructions stored in the internal memory 1821, so that the communication apparatus 1800 performs the communication method provided in some embodiments of this application, various applications, data processing, and the like. The internal memory 1821 may include a code storage area and a data storage area. The code storage area may store an operating system. The data storage area may store data created during use of the communication apparatus 1800, and the like. In addition, the internal memory 1821 may include a high-speed random access memory, or may include a nonvolatile memory, for example, one or more magnetic disk storage devices, a flash memory device, or a universal flash storage (universal flash storage, UFS). In some embodiments, the processor 1810 runs the instructions stored in the internal memory 1821 and/or the instructions stored in the memory disposed in the processor 1810, so that the communication apparatus 1800 performs the communication method provided in embodiments of this application.

It should be understood that, for a specific process of performing the foregoing corresponding steps by the communication apparatus 1800, refer to related descriptions of the steps performed by the intra-network node or the second participant node described with reference to FIG. 5. For brevity, details are not described herein again.

FIG. 19 is a block diagram of another example of a communication apparatus 1900 according to an embodiment of this application. The communication apparatus 1900 may correspond to the intra-network node or the second participant node described in the embodiments of the method 500. Alternatively, the communication apparatus 1900 may be a chip or a component applied to the intra-network node or the second participant node. In addition, modules or units in the communication apparatus 1900 are separately configured to perform actions or processing processes performed by the intra-network node or the second participant node described in the embodiments of the method 500. As shown in FIG. 19, the communication apparatus 1900 may include a processing unit 1910 and a communication unit 1920. Optionally, the communication apparatus 1900 may further include a storage unit 1930.

It should be understood that, for a specific process of performing the foregoing corresponding steps by the units in the communication apparatus 1900, refer to related descriptions of the steps performed by the intra-network node or the second participant node described with reference to the embodiments in FIG. 5. For brevity, details are not described herein again.

Optionally, the communication unit 1920 may include a receiving unit (module) and a sending unit (module), configured to perform steps of receiving information and sending information by the terminal device or the server in the foregoing method embodiments. The storage unit 1930 is configured to store instructions executed by the processing unit 1910 and the communication unit 1920. The processing unit 1910, the communication unit 1920, and the storage unit 1930 are communicatively connected. The storage unit 1930 stores instructions. The processing unit 1910 is configured to execute the instructions stored in the storage unit. The communication unit 1920 is configured to perform specific signal receiving and sending under driving of the processing unit 1910.

It should be understood that the communication unit 1920 may be a transceiver, an input/output interface, an interface circuit, or the like. For example, the communication unit 1920 may be implemented by the wireless communication module 1850 in the embodiment shown in FIG. 18. The storage unit may be a memory. For example, the storage unit may be implemented by the interface 1820 for external memory and the internal memory 1821 in the embodiment shown in FIG. 18. The processing unit 1910 may be implemented by the processor 1810 in the embodiment shown in FIG. 18, or may be implemented by the processor 1810, the interface 1820 for external memory, and the internal memory 1821.

It should be further understood that the communication apparatus 1900 shown in FIG. 19 may be an intra-network node or a participant node, or the intra-network node or the participant node may include the communication apparatus 1900 shown in FIG. 19.

An embodiment of this application further provides a chip system. As shown in FIG. 20, the chip system includes at least one processor 2010 and at least one interface circuit 2020. The processor 2010 and the interface circuit 2020 may be interconnected through a line. For example, the interface circuit 2020 may be configured to receive a signal from another apparatus (for example, a server). For another example, the interface circuit 2020 may be configured to send a signal to another apparatus. For example, the interface circuit 2020 may read instructions stored in the memory, and send the instructions to the processor 2010. When the instructions are executed by the processor 2010, the chip system may be enabled to perform the steps performed by the centralized node, the intra-network node, or the participant node in the foregoing embodiments. Certainly, the chip system may further include another discrete component. This is not specifically limited in this embodiment of this application.

It should be further understood that division into the units in the apparatus is merely logical function division. During actual implementation, all or some of the units may be integrated into one physical entity, or may be physically separated. In addition, all the units in the apparatus may be implemented in a form of software invoked by a processing element, or may be implemented in a form of hardware; or some units may be implemented in a form of software invoked by a processing element, and some units may be implemented in a form of hardware. For example, each unit may be a separately disposed processing element, or may be integrated into a chip of the apparatus for implementation. In addition, each unit may alternatively be stored in a memory in a form of a program to be invoked by a processing element of the apparatus to perform a function of the unit. The processing element herein may also be referred to as a processor, and may be an integrated circuit having a signal processing capability. In an implementation process, steps in the foregoing methods or the foregoing units may be implemented by using a hardware integrated logic circuit in a processor element, or may be implemented in a form of software invoked by the processing element. In an example, a unit in any one of the foregoing apparatuses may be one or more integrated circuits configured to implement the foregoing methods, for example, one or more application-specific integrated circuits (application-specific integrated circuits, ASICs), one or more digital signal processors (digital signal processors, DSPs), one or more field programmable gate arrays (field programmable gate arrays, FPGAs), or a combination of at least two of these integrated circuit forms. For another example, when the unit in the apparatus is implemented in a form of scheduling a program by the processing element, the processing element may be a general-purpose processor, for example, a central processing unit (central processing unit, CPU) or another processor that may invoke the program. For another example, the units may be integrated together and implemented in a form of a system-on-a-chip (system-on-a-chip, SoC).

An embodiment of this application further provides an apparatus. The apparatus is included in a centralized node, an intra-network node, or a participant node. The apparatus has a function of implementing the centralized node, the intra-network node, or the participant node in any method in the foregoing embodiments. The function may be implemented by hardware, or may be implemented by hardware executing corresponding software. The hardware or the software includes at least one module or unit corresponding to the foregoing function, for example, a determining module or unit, a calculation module or unit, a sending module or unit, and a receiving module or unit.

An embodiment of this application further provides a computer-readable storage medium, configured to store computer program code. The computer program includes instructions used to perform any communication method provided in the foregoing embodiments of this application. The readable medium may be a read-only memory (read-only memory, ROM) or a random access memory (random access memory, RAM). This is not limited in embodiments of this application.

This application further provides a computer program product. The computer program product includes instructions. When the instructions are executed, the terminal and the server are enabled to perform corresponding operations corresponding to the foregoing communication methods.

This application further provides a communication system. The system includes a centralized node (for example, a first node), an intra-network node (a second node), and a participant node (a third node). Optionally, there may be a plurality of centralized nodes (the first node and a fourth node). For example, the communication system includes a first centralized node, a second centralized node, an intra-network node, and a second participant node that are shown in FIG. 5.

An embodiment of this application further provides a chip disposed in a communication apparatus. The chip includes a processing unit and a communication unit. The processing unit may be, for example, a processor, and the communication unit may be, for example, an input/output interface, a pin, or a circuit. The processing unit may execute computer instructions, so that the communication apparatus performs any communication method provided in the foregoing embodiments of this application.

Optionally, the computer instructions are stored in a storage unit.

Optionally, the storage unit is a storage unit in the chip, for example, a register or a cache. Alternatively, the storage unit may be a storage unit that is in the terminal and that is located outside the chip, for example, a ROM, another type of static storage device that can store static information and instructions, or a random RAM. Any processor mentioned above may be a CPU, a microprocessor, an ASIC, or one or more integrated circuits configured to control program execution of the feedback information transmission method. The processing unit and the storage unit may be decoupled, are disposed on different physical devices respectively, and are connected in a wired or wireless manner to implement respective functions of the processing unit and the storage unit, to support the system chip in implementing various functions in the foregoing embodiments. Alternatively, the processing unit and the memory may be coupled to the same device.

The centralized node, the intra-network node, the participant node, the computer-readable storage medium, the computer program product, and the chip provided in embodiments are all configured to perform the corresponding methods provided above. Therefore, for beneficial effects that can be achieved thereof, refer to the beneficial effects of the corresponding methods provided above. Details are not described herein again.

It may be understood that the memory in embodiments of this application may be a volatile memory or a non-volatile memory, or may include both a volatile memory and a non-volatile memory. The non-volatile memory may be a ROM, a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a RAM, and serves as an external cache. There are a plurality of different types of RAMs, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (double data rate SDRAM, DDR SDRAM), an enhanced synchronous dynamic random access memory (enhanced SDRAM, ESDRAM), a synchlink dynamic random access memory (synchlink DRAM, SLDRAM), and a direct rambus random access memory (direct rambus RAM, DR RAM).

In this application, names may be assigned to various objects such as messages/information/devices/network elements/systems/apparatuses/actions/operations/procedures/concepts. It can be understood that the specific names do not constitute a limitation on the related objects. The assigned names may vary with factors such as scenarios, contexts, or usage habits. Understanding of technical meanings of technical terms in this application should be determined mainly based on functions and technical effects embodied/performed by the technical terms in the technical solutions.

In embodiments of this application, unless otherwise stated or there is a logic conflict, terms and/or descriptions between different embodiments are consistent and may be mutually referenced, and technical features in different embodiments may be combined based on an internal logical relationship thereof, to form a new embodiment.

A person of ordinary skill in the art may be aware that, in combination with the examples described in embodiments disclosed in this specification, units and algorithm steps can be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of this application.

All or some of the methods in embodiments of this application may be implemented by software, hardware, firmware, or any combination thereof. When software is used to implement embodiments, all or some of embodiments may be implemented in a form of a computer program product. The computer program product includes one or more computer programs or instructions. When the computer programs or instructions are loaded and executed on a computer, the procedures or functions in embodiments of this application are completely or partially executed. The computer may be a general-purpose computer, a dedicated computer, a computer network, or other programmable apparatuses. The computer programs or instructions may be stored in a computer-readable storage medium, or may be transmitted through the computer-readable storage medium. The computer-readable storage medium may be any usable medium that can be accessed by a computer, or a data storage device, such as a server, integrating one or more usable media.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In the several embodiments provided in this application, it should be understood that the disclosed system, apparatus, and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, and may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit.

When the functions are implemented in a form of a software functional unit and sold or used as an independent product, the functions may be stored in a computer-readable storage medium. Based on such an understanding, the technical solutions of this application essentially, or the part contributing to the prior art, or some of the technical solutions may be implemented in a form of a software product. The computer software product is stored in a readable storage medium, and includes several instructions for enabling a computer device (which may be a personal computer, a server, or a network device) to perform all or some of the steps of the methods described in embodiments of this application. The foregoing readable storage medium includes any medium that can store program code, for example, a USB flash drive, a removable hard disk, a ROM, a RAM, a magnetic disk, or an optical disc.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication system, wherein the system comprises a first node, at least one second node, and a third node, wherein
the first node is configured to send indication information to the at least one second node, wherein the indication information indicates the second node to send probing information, and the at least one second node is a node for which the first node performs configuration indication;
the at least one second node is configured to send probing information based on the indication information;
the at least one second node is further configured to detect a preamble that is sent by the third node and that is in response to the probing information;
the at least one second node is further configured to separately send first information to the first node, wherein the first information comprises an identifier of a preamble detected in each time unit; and
the first node is further configured to determine multi-hop network topology information based on the first information respectively fed back by the at least one second node.

2. The system according to claim 1, wherein the at least one second node is located in a bottleneck area, the bottleneck area is a bottleneck area that is in a first network and that is managed by the first node, and the bottleneck area comprises a plurality of third nodes.

3. The system according to claim 2, wherein the system further comprises a fourth node, the third node is a node for which the fourth node performs configuration indication, and the indication information comprises time-frequency resource configuration information for sending the probing information; and before the first node sends the indication information to the at least one second node, the first node is further configured to send bottleneck request information to the fourth node, wherein the bottleneck request information comprises at least one of location information of the bottleneck area and expected active time information of the third node in the bottleneck area, the active time information comprises at least one of a active time range and active time periodicity configuration information, and the third node is a node in an idle or inactive state in a second network;
the fourth node is further configured to send bottleneck request response information to the first node, wherein the bottleneck request response information comprises active time information of the third node in the bottleneck area; and
the first node determines, based on the bottleneck request response information, a time domain resource for sending the probing information.

4. The system according to claim 3, wherein active time that is of the third node and that is comprised in the bottleneck request response information and the time domain resource for sending the probing information at least partially overlap.

5. The system according to claim 3, wherein the time-frequency resource configuration information for the probing information comprises:
the time-frequency resource occupied for sending the probing information.

6. The system according to claim 3, wherein the time-frequency resource configuration information for the probing information comprises configuration information of a first resource pool and configuration information of a plurality of candidate resources in the first resource pool, and a time domain resource of each candidate resource corresponds to a set or a subset of active time of the third node; and
the at least one second node is further configured to separately select a target resource from the plurality of candidate resources to send the probing information.

7. The system according to claim 1, wherein the third node is configured to:
select an i^{th} time unit from X configured time units; and
if the i^{th} time unit is a 1^{st} time unit, send, by the third node, a preamble of the third node in the i^{th} time unit; or
if the i^{th} time unit is not a 1^{st} time unit, monitor, by the third node in a time unit before the i^{th} time unit, a preamble sent by a surrounding node, and send, in the i^{th} time unit, a preamble of the third node and the preamble that is sent by the surrounding node and that is monitored in the time unit before the i^{th} time unit.

8. The system according to claim 1, wherein the third node is configured to:
send a preamble of the third node in each of first X-1 time units in X configured time units, monitor, in each of the first X-1 time units, a preamble sent by a surrounding node, and send, in a last time unit in the X time units, the preamble of the third node and the preamble that is sent by the surrounding node that is monitored in the first X-1 time units.

9. The system according to claim 1, wherein the probing information comprises at least one of a primary synchronization sequence and a secondary synchronization sequence, current reference time indication information, configuration information for sending a preamble by the third node, and an identifier of the second node, the configuration information for sending the preamble by the third node comprises at least one of a time domain resource configuration for sending the preamble by the third node, a threshold for sending the preamble by the third node, and a preamble sequence set, and the preamble sequence set comprises a root sequence and a cyclic shift manner.

10. The system according to claim 1, wherein the at least one second node broadcasts the probing information.

11. A communication method, wherein the method comprises:
sending, by a first node, indication information to at least one second node, wherein the indication information indicates the second node to send probing information, and the at least one second node is a node for which the first node performs configuration indication;
sending, by the at least one second node, probing information based on the indication information;
detecting, by the at least one second node, a preamble that is sent by a third node and that is in response to the probing information;
separately sending, by the at least one second node, first information to the first node, wherein the first information comprises an identifier of a preamble detected in each time unit; and
determining, by the first node, multi-hop network topology information based on the first information respectively fed back by the at least one second node.

12. The method according to claim 11, wherein the at least one second node is located in a bottleneck area, the bottleneck area is a bottleneck area that is in a first network and that is managed by the first node, and the bottleneck area comprises a plurality of third nodes.

13. The method according to claim 12, wherein the indication information comprises time-frequency resource configuration information for sending the probing information, the third node is a node for which a fourth node performs configuration indication, and before sending, by the first node, the indication information to the at least one second node, the method further comprises:
sending, by the first node, bottleneck request information to the fourth node, wherein the bottleneck request information comprises at least one of location information of the bottleneck area and expected active time information of the third node in the bottleneck area, the active time information comprises at least one of a active time range and active time periodicity configuration information, and a third node is a node in an idle or inactive state in the second network;
sending, by the fourth node, bottleneck request response information to the first node, wherein the bottleneck request response information comprises active time information of the third node in the bottleneck area; and
determining, by the first node based on the bottleneck request response information, a time domain resource for sending the probing information.

14. The method according to claim 13, wherein active time that is of the third node and that is comprised in the bottleneck request response information and the time domain resource for sending the probing information at least partially overlap.

15. The method according to claim 13, wherein the time-frequency resource configuration information for the probing information comprises:
the time-frequency resource occupied for sending the probing information.

16. The method according to claim 13, wherein the time-frequency resource configuration information for the probing information comprises configuration information of a first resource pool and configuration information of a plurality of candidate resources in the first resource pool, and a time domain resource of each candidate resource corresponds to a set or a subset of active time of the third node; and
the method further comprises: separately selecting, by the at least one second node, a target resource from the plurality of candidate resources to send the probing information.

17. The method according to claim 11, wherein the method further comprises:
selecting, by the third node, an i^{th} time unit from the X configured time units; and
if the i^{th} time unit is a 1^{st} time unit, sending, by the third node, a preamble of the third node in the i^{th} time unit; or
if the i^{th} time unit is not a 1^{st} time unit, monitoring, by the third node in a time unit before the i^{th} time unit, a preamble sent by a surrounding node, and sending, in the i^{th} time unit, a preamble of the third node and the preamble that is sent by the surrounding node and that is monitored in the time unit before the i^{th} time unit.

18. The method according to claim 11, wherein the method further comprises:
sending, by the third node, a preamble of the third node in each of first X-1 time units in X configured time units, monitor, in each of the first X-1 time units, a preamble sent by a surrounding node, and sending, in a last time unit in the X time units, the preamble of the third node and the preamble that is sent by the surrounding node that is monitored in the first X-1 time units.

19. The method according to claim 11, wherein the probing information comprises at least one of a primary synchronization sequence and a secondary synchronization sequence, current reference time indication information, configuration information for sending a preamble by the third node, and an identifier of the second node, the configuration information for sending the preamble by the third node comprises at least one of a time domain resource configuration for sending the preamble by the third node, a threshold for sending the preamble by the third node, and a preamble sequence set, and the preamble sequence set comprises a root sequence and a cyclic shift manner.

20. A communication method, wherein the method comprises:
sending, by a first node, indication information to at least one second node, wherein the indication information indicates the second node to send probing information, and the at least one second node is a node for which the first node performs configuration indication;
receiving, by the first node, first information respectively sent by the at least one second node, wherein the first information comprises a preamble, in response to the probing information, that is sent by a third node and that is detected in each time unit; and
determining, by the first node, multi-hop network topology information based on the first information respectively fed back by the at least one second node.
